(19) United States
(12) Patent Application Publication
(10) Pub. No.: US 2026/0197381 A1
(43) Pub. Date: Jul. 9, 2026

(54) FOLDABLE ELECTRONIC DEVICE INCLUDING MAGNETIC SENSOR AND METHOD FOR PREVENTING OPEN/CLOSED RECOGNITION MALFUNCTION THEREOF

(71) Applicant: Samsung Electronics Co., Ltd., Suwon-si (KR)

(72) Inventors: Seajung OH, Suwon-si (KR); Kihun EOM, Suwon-si (KR)

(21) Appl. No.: 19/551,135

(22) Filed: Feb. 26, 2026

Related U.S. Application Data
(63) Continuation of application No. PCT/KR2024/013120, filed on Sep. 2, 2024.

(30) Foreign Application Priority Data
Sep. 6, 2023 (KR) 10-2023-0118460
Oct. 11, 2023 (KR) 10-2023-0135339

(51) Int. Cl. H04M 1/02; H04M 1/72454

(52) U.S. Cl. CPC H04M 1/0243; H04M 1/0216; H04M 1/0268; H04M 1/72454

(57) ABSTRACT

An electronic device is provided. The electronic device includes a first housing, a second housing foldably coupled to the first housing, a first magnetic body disposed in the first housing, a second magnetic body disposed in the second housing, a first sensor configured to detect a change in magnetic force based on a distance between the first magnetic body and the second magnetic body, at least one second sensor configured to detect a folding angle between the first housing and the second housing, a first processor connected to the first sensor through a first data line and an interrupt line, the first data line being configured to transfer first sensor data and the interrupt line being configured to transfer an interrupt signal in response to a magnetic force condition being satisfied based on a change in magnetic force, a second processor connected to the at least one second sensor through a second data line configured to transfer second sensor data, the second data line branching off from a node of the interrupt line so as to be connected to the first sensor, and memory, comprising one or more storage media, storing executable instructions, wherein the instructions, when executed by at least one of the first processor or the second processor, cause the first sensor to output a first interrupt signal indicating a second state to the first processor and the second processor through the interrupt line in case that, while the electronic device is recognized as being in a first state, a first recognition condition which causes a change from the first state to the second state is satisfied by a change in magnetic field measured by the first sensor, the second processor to activate the at least one second sensor and angle calculation processing circuitry in response to receiving the first interrupt signal, thereby calculating the folding angle between the first housing and the second housing, and the first processor or the second processor to maintain recognition of the first state in case that the folding angle is included in a first state condition, and recognize that the electronic device has changed to the second state in case that the folding angle is outside the first state condition.

### CROSS-REFERENCE TO RELATED APPLICATION(S)

This application is a continuation application, claiming priority under 35 U.S.C. § 365(c), of an International application No. PCT/KR2024/013120, filed on Sep. 2, 2024, which is based on and claims the benefit of a Korean patent application number 10-2023-0118460, filed on Sep. 6, 2023, in the Korean Intellectual Property Office, and of a Korean patent application number 10-2023-0135339, filed on Oct. 11, 2023, in the Korean Intellectual Property Office, the disclosure of each of which is incorporated by reference herein in its entirety.

### BACKGROUND

### 1. Field

The disclosure relates to a foldable electronic device including a magnetic force sensor and a method for preventing opening/closing recognition erroneous operations thereof.

### 2. Description of Related Art

In order to meet the needs of users who desire newer and more diverse functions, electronic devices are evolving into structures that expand the display or improve the utilization of the display. For example, an electronic device (e.g., a foldable electronic device) may be implemented to operate in an in-folding, out-folding, or in/out-folding manner by rotating first and second housings with respect to each other.

The above information is presented as background information only to assist with an understanding of the disclosure. No determination has been made, and no assertion is made, as to whether any of the above might be applicable as prior art with regard to the disclosure.

### SUMMARY

An electronic device (e.g., a foldable electronic device) formed to be folded with regard to each other with reference to a folding axis may recognize the open/closed state (e.g., open state, closed state, and intermediate state) of the electronic device by using a magnetic force sensor (e.g., a Hall sensor). The magnetic force sensor may measure a magnetic force value (or magnetic field strength/magnetic force data) according to the distance from a magnetic material. The electronic device may compare the magnetic value detected by the magnetic force sensor with an opening/closing recognition condition to recognize whether the electronic device is in an open state or a closed state.

However, the magnetic force sensor may also experience a change in the magnetic value due to approach of external magnetic bodies other than magnetic bodies (or internal magnetic bodies) mounted on the electronic device to interact with the magnetic force sensor. Since external magnetic bodies have different magnetic force values depending on the size or type, it may be difficult for the electronic device to distinguish each approaching external magnetic body.

Changes in value from the magnetic force sensor caused by external magnetic bodies may be included in opening/closing recognition conditions, thereby causing opening/closing recognition errors during the operation of the electronic device. (e.g., being recognized as currently in an open state or a closed state). In addition, even in the open state of the electronic device, the electronic device may be erroneously recognized as being in the closed state due to an approaching external magnetic object, and this may result in erroneous operations regarding execution of functions according to the state of the electronic device (e.g., switching to the closed state during a call terminates the call).

Aspects of the disclosure are to address at least the above-mentioned problems and/or disadvantages and to provide at least the advantages described below. Accordingly, an aspect of the disclosure is to provide a method and a device wherein folding angle sensors used for switching display screens are used to determine whether a change in magnetic force is an intended change or an unintended change, thereby preventing erroneous operations according to electronic device opening/closing recognition.

Additional aspects will be set forth in part in the description which follows and, in part, will be apparent from the description, or may be learned by practice of the presented embodiments.

In accordance with an aspect of the disclosure, an electronic device is provided. The electronic device includes a first housing, a second housing foldably coupled to the first housing, a first magnetic body disposed in the first housing, a second magnetic body disposed in the second housing, a first sensor configured to detect a change in magnetic force based on a distance between the first magnetic body and the second magnetic body, at least one second sensor configured to detect a folding angle between the first housing and the second housing, a first processor connected to the first sensor through a first data line and an interrupt line, the first data line being configured to transfer data from the magnetic force sensor and the interrupt line being configured to transfer an interrupt signal in response to a magnetic force condition being satisfied based on a change in magnetic force, a second processor connected to the at least one second sensor through a second data line configured to transfer second data, the second data line branching off from a node of the interrupt line so as to be connected to the first sensor, and memory, comprising one or more storage media, storing executable instructions, wherein the instructions, when executed by at least one of the first processor or the second processor, cause the first sensor to output a first interrupt signal indicating a second state to the first processor and the second processor through the interrupt line in case that, while the electronic device is recognized as being in a first state, a first recognition condition which causes a change from the first state to the second state is satisfied by a change in magnetic field measured by the first sensor, the second processor to activate the at least one second sensor and angle calculation processing circuitry in response to receiving the first interrupt signal, thereby calculating the folding angle between the first housing and the second housing, and the first processor or the second processor to maintain recognition of the first state in case that the folding angle is included in a first state condition, and recognize that the electronic device has changed to the second state in case that the folding angle is outside the first state condition.

In accordance with another aspect of the disclosure, a method performed by an electronic device for preventing opening/closing recognition erroneous operations of the electronic device including a first housing, a second housing foldably coupled to the first housing, a first magnetic body disposed in the first housing, a second magnetic body disposed in the second housing, a first sensor configured to detect a change in magnetic force according to a distance between the first magnetic body and the second magnetic body, at least one second sensor configured to detect a folding angle between the first housing and the second housing, a first processor connected to the first sensor through a first data line and an interrupt line, the first data line being configured to transfer first sensor data and the interrupt line being configured to transfer an interrupt signal in case that a magnetic force condition is satisfied based on the change in magnetic force, a second processor connected to the at least one second sensor through a second data line configured to transfer data from the at least one second sensor, the second data line branching off from a node of the interrupt line so as to be connected to the first sensor, and memory, comprising one or more storage media, storing instructions, is provided. The method includes outputting, by the first sensor, a first interrupt signal indicating a second state to the first processor and the second processor through the interrupt line in case that, while the electronic device is recognized as being in a first state, a first recognition condition which causes a change from the first state to the second state is satisfied by a change in magnetic field measured by the first sensor, activating, by the second processor, the at least one second sensor and angle calculation processing circuitry in response to receiving the first interrupt signal, thereby calculating the folding angle between the first housing and the second housing, maintaining, by the first processor or the second processor, recognition of the first state in case that the folding angle is included in a first state condition, and recognizing that the electronic device has changed from the first state to the second state in case that the folding angle is outside the first state condition.

In accordance with another aspect of the disclosure, one or more non-transitory computer-readable storage media storing one or more computer programs including computer-executable instructions that, when executed by one or more processors of an electronic device individually or collectively, in which the electronic device includes a first housing, a second housing foldably coupled to the first housing, a first magnetic body disposed in the first housing, a second magnetic body disposed in the second housing, a first sensor configured to detect a change in magnetic force according to a distance between the first magnetic body and the second magnetic body, at least one second sensor configured to detect a folding angle between the first housing and the second housing, a first processor connected to the first sensor through a first data line and an interrupt line, the first data line being configured to transfer first sensor data and the interrupt line being configured to transfer an interrupt signal in case that a magnetic force condition is satisfied based on the change in magnetic force, a second processor connected to the at least one second sensor through a second data line configured to transfer data from the at least one second sensor, the second data line branching off from a node of the interrupt line so as to be connected to the first sensor, and memory, comprising one or more storage media, storing instructions, cause the electronic device to perform operations are provided. The operation include outputting, by the first sensor, a first interrupt signal indicating a second state to the first processor and the second processor through the interrupt line in case that, while the electronic device is recognized as being in a first state, a first recognition condition which causes a change from the first state to the second state is satisfied by a change in magnetic field measured by the first sensor, activating, by the second processor, the at least one second sensor and angle calculation processing circuitry in response to receiving the first interrupt signal, thereby calculating the folding angle between the first housing and the second housing, maintaining, by the first processor or the second processor, recognition of the first state in case that the folding angle is included in a first state condition, and recognizing that the electronic device has changed from the first state to the second state in case that the folding angle is outside the first state condition.

The electronic device of the disclosure includes a computer-readable recording medium in which a program for implementing a method for preventing opening/closing recognition erroneous operations is recorded.

According to various embodiments, interrupt signals from a magnetic force sensor for determining the opening/closing state (e.g., open state, closed state, or intermediate state) of an electronic device are transferred to a processing unit (e.g., an auxiliary processor or a sensor hub) for controlling folding angle calculation such that the opening/closing state can be monitored (or re-determined) through the folding angle calculation without delay, and the opening/closing state can be stably determined without errors.

According to various embodiments, the folding angle sensor is activated without the involvement of the main processor or the application processor, and used to recognize the opening/closing of the electronic device, thereby identifying whether a change in magnetic force is an intended change or an unintended change.

According to various embodiments, the electronic device's opening/closing information is stably recognized, thereby preventing erroneous operations due to erroneous recognition of the electronic device's state.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2A is a front perspective view of an electronic device in an unfolded state (or folded state) according to an embodiment of the disclosure;

FIG. 2B is a plan view illustrating the front surface of an electronic device in an unfolded state according to an embodiment of the disclosure;

FIG. 2C is a plan view illustrating the rear surface of an electronic device in an unfolded state according to an embodiment of the disclosure;

FIG. 3A is a perspective view of an electronic device in a folding state according to an embodiment of the disclosure;

FIG. 3B is a perspective view of an electronic device in an intermediate state according to an embodiment of the disclosure;

FIG. 4 is an exploded perspective drawing of an electronic device according to an embodiment of the disclosure;

FIG. 5 is a diagram illustrating the arrangement of a magnetic force sensor, magnetic bodies, and a folding angle sensor included in an electronic device according to an embodiment of the disclosure;

FIG. 6 illustrates components of an opening/closing recognition structure of an electronic device according to an embodiment of the disclosure;

FIG. 7 illustrates a graph showing a change in the magnetic force according to the folding angle when the electronic device transitions from the open state to the closed state according to an embodiment of the disclosure;

FIGS. 8A and 8B are flowcharts of a method for preventing recognition erroneous operations of an electronic device including a magnetic force sensor according to various embodiments of the disclosure;

FIG. 9 illustrates components of an opening/closing recognition structure of an electronic device according to an embodiment of the disclosure;

FIG. 10 is a flowchart of a method for preventing recognition erroneous operations of an electronic device including a magnetic force sensor according to an embodiment of the disclosure; and

FIG. 11 is a flowchart of a method for preventing recognition erroneous operations of an electronic device including a magnetic force sensor according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Electronic devices according to an embodiment disclosed in the document may be devices of various types. The electronic devices may include, for example, a portable communication device (e.g., a smartphone), a computer device, a portable multimedia device, a portable medical device, a camera, a wearable device, or a home appliance. Electronic devices according to an embodiment of the disclosure are not limited to the above-mentioned devices.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi™) chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

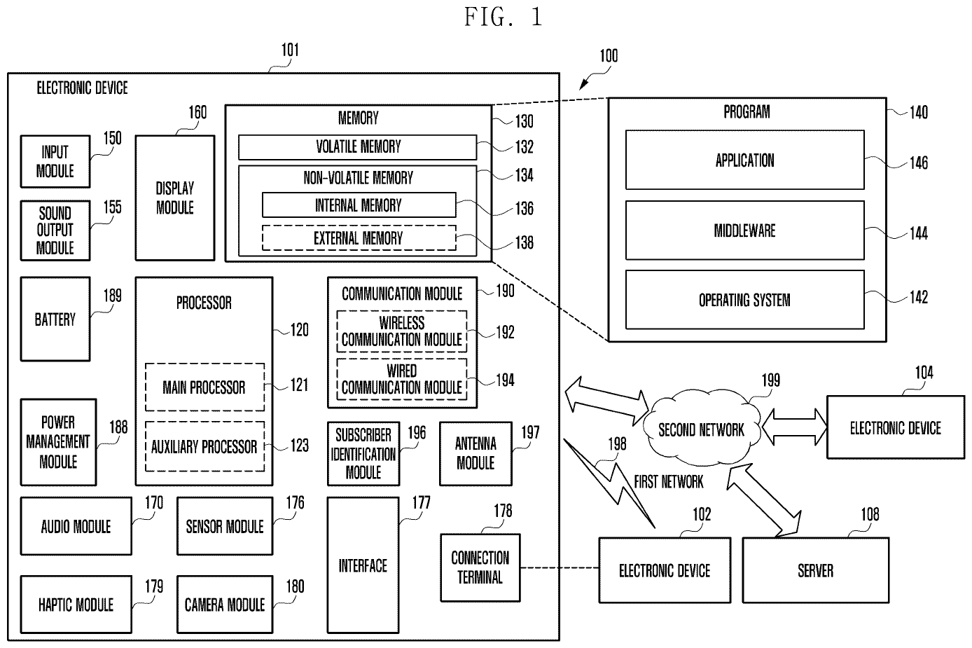

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In some embodiments, at least one of the components (e.g., the connection terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connection terminal 178 may include a connector via which the electronic device 101 may be physically connected with the external electronic device (e.g., the electronic device 102). According to an embodiment, the connection terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi™) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter-wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mm Wave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices (e.g., the electronic device 102, the electronic device 104, and the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IOT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

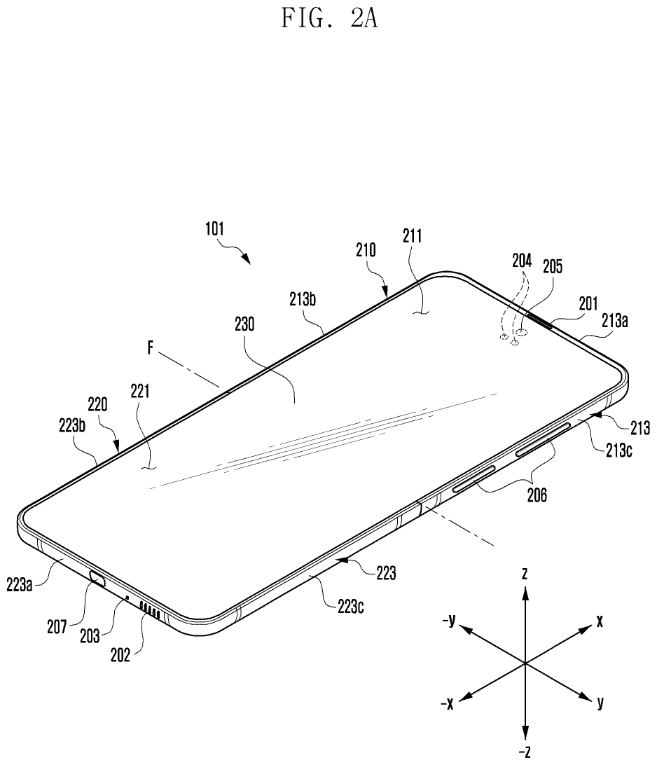

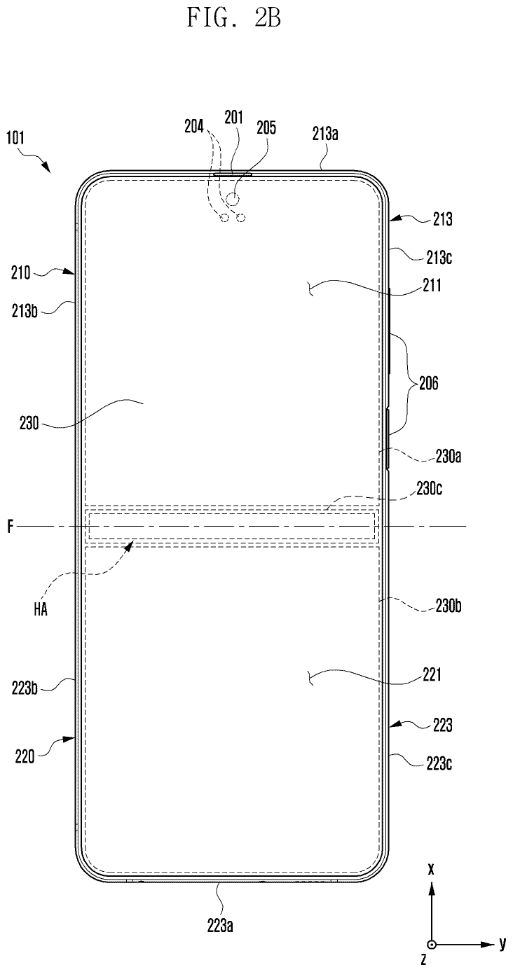

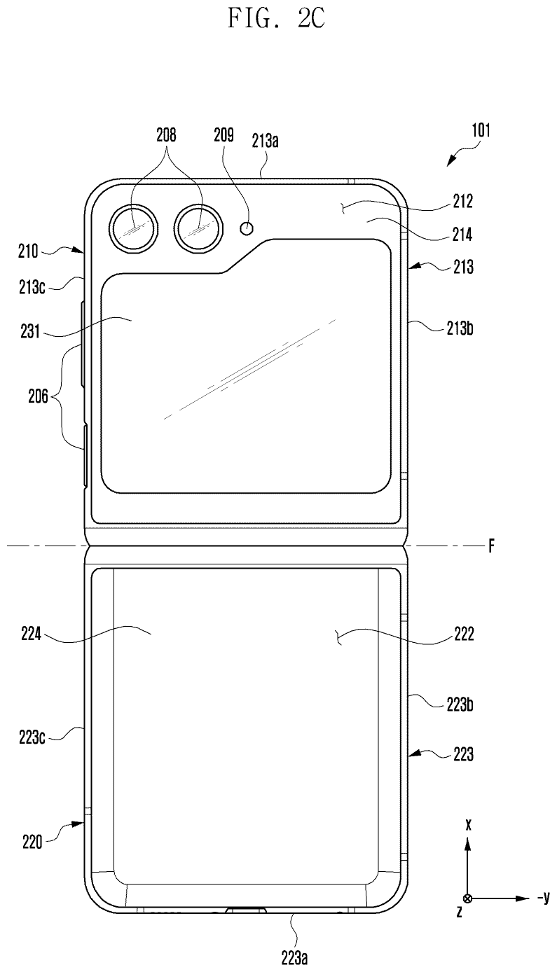

FIG. 2A is a front perspective view of an electronic device in an unfolded state (or a folded state) according to an embodiment of the disclosure.

FIG. 2B is a plan view illustrating the front surface of an electronic device in an unfolded state according to an embodiment of the disclosure.

FIG. 2C is a plan view illustrating the rear surface of an electronic device in an unfolded state according to an embodiment of the disclosure.

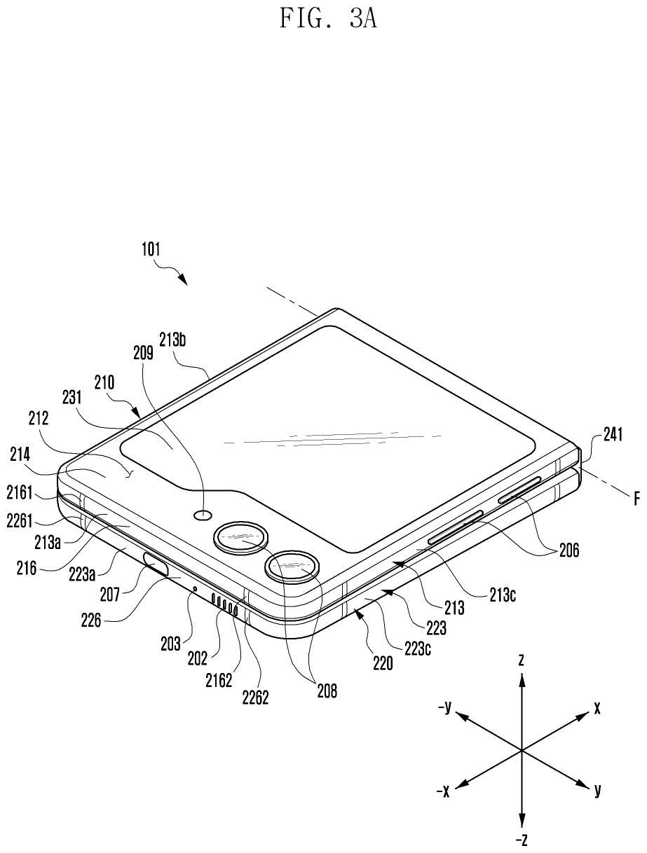

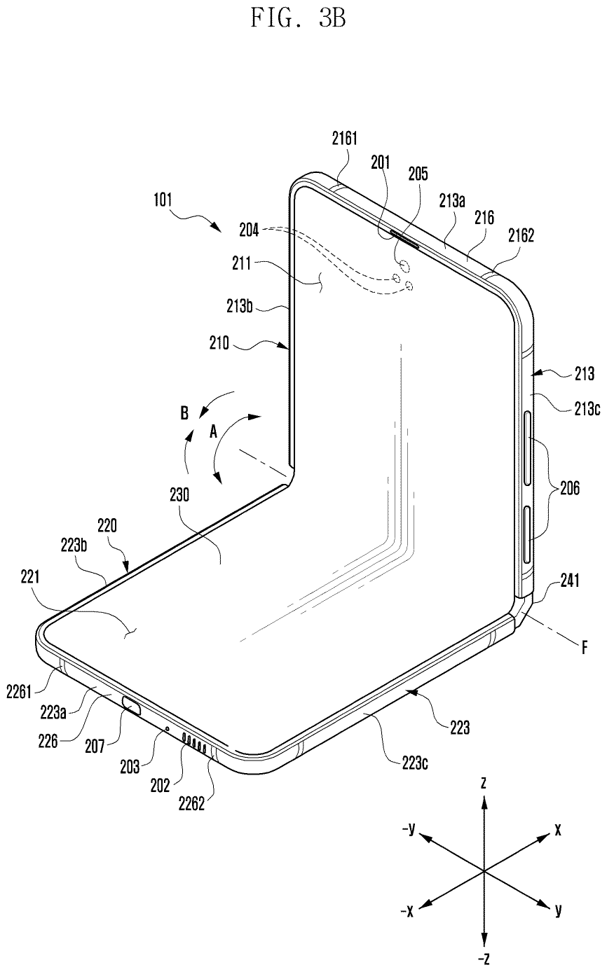

FIG. 3A is a perspective view of an electronic device in a folding state according to an embodiment of the disclosure.

FIG. 3B is a perspective view of an electronic device in an intermediate state according to an embodiment of the disclosure.

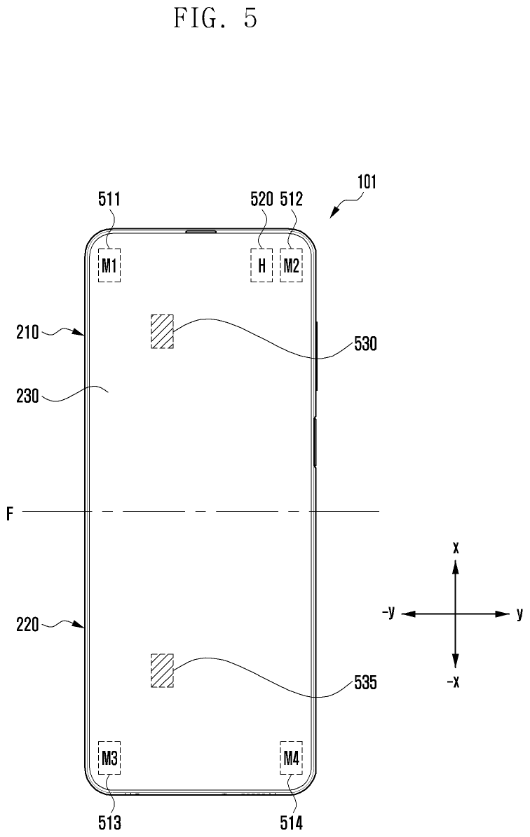

Referring to FIGS. 2A to 2C, 3A, and 3B, an electronic device 101 (e.g., a foldable electronic device) may include a first housing 210 (e.g., a first housing portion or a first housing structure) and a second housing 220 (e.g., a second housing portion or a second housing structure) coupled to each other to be foldable with regard to a hinge device (e.g., a hinge assembly HA in FIG. 2B) (e.g., the hinge assembly HA in FIG. 5) (e.g., a hinge module or a hinge structure). In an embodiment, the first housing 210, the second housing 220, and the hinge device (e.g., the hinge assembly HA in FIG. 2B) may include a foldable housing (e.g., a housing, a foldable housing structure, or a housing structure). In an embodiment, the hinge device (e.g., the hinge assembly HA in FIG. 2B) may be disposed in the x-axis direction or in the y-axis direction. In an embodiment, the electronic device 101 may include a first display 230 (e.g., a flexible display, a foldable display, or a main display) disposed in an area (e.g., a recess) formed by the first and second housings 210 and 220. In an embodiment, the first housing 210 and the second housing 220 may be disposed on both sides of the folding axis F and may be shaped to be substantially symmetrical with respect to the folding axis F. In an embodiment, the angle or distance between the first housing 210 and the second housing 220 may vary according to the state of the electronic device 101. For example, depending on whether the electronic device is in an unfolded state (or flat state), a folded state (or folding state), or an intermediate state, the angle or distance between the first housing 210 and the second housing 220 may vary.

According to various embodiments, the first housing 210 may include a first surface 211 facing in a first direction (e.g., the front direction) (in the z-axis direction) in the unfolded state of the electronic device 101, and a second surface 212 facing in a second direction (e.g., the rear direction) (in the −z-axis direction), opposite to the first surface 211. In an embodiment, the second housing 220 may include a third surface 221 facing in the first direction (z-axis direction) in the unfolded state of the electronic device 101, and a fourth surface 222 facing in the second direction (−z-axis direction). In an embodiment, in the unfolded state of the electronic device 101, the first surface 211 of the first housing 210 and the third surface 221 of the second housing 220 may face in the substantially same first direction (the z-axis direction). In an embodiment, in the folded state of the electronic device 101, the first surface 211 of the first housing 210 and the third surface 221 of the second housing 220 may face each other. In an embodiment, in the unfolded state of the electronic device 101, the second surface 212 of the first housing 210 and the fourth surface 222 of the second housing 220 may face in substantially the same second direction (the −z-axis direction). In an embodiment, in the folded state of the electronic device 101, the second surface 212 of the first housing and the fourth surface 222 of the second housing 220 may face in opposite directions. For example, in the folded state of the electronic device 101, the second surface 212 may face in the first direction (the z-axis direction), and the fourth surface 222 may face in the second direction (the −z-axis direction). In this case, the first display 230 may not be visible from the outside (in-folding type). In an embodiment, the electronic device 101 may be folded such that the second surface 212 of the first housing 210 and the fourth surface 222 of the second housing 220 face each other. In this case, the first display 230 may be disposed to be visible from the outside (out-folding type).

According to various embodiments, the first housing 210 (e.g., a first housing structure) may include a first side member 213 which at least partially forms the exterior of the electronic device 101, and a first rear cover 214 which is coupled to the first side member 213 and forms at least a portion of the second surface 212 of the electronic device 101. In an embodiment, the first side member 213 may include a first side surface 213a, a second side surface 213b extending from one end of the first side 213a, and a third side surface 213c extending from the other end of the first side 213a. In an embodiment, the first side member 213 may be formed in a rectangular shape (e.g., a square or a rectangle) through the first side surface 213a, the second side surface 213b, and the third side surface 213c.

According to various embodiments, the second housing 220 (e.g., a second housing structure) may include a second side member 223 which at least partially forms the exterior of the electronic device 101, and a second rear cover 224 which is coupled to the second side member 223 and forms at least a portion of the fourth surface 222 of the electronic device 101. In an embodiment, the second side member 223 may include a fourth side surface 223a, a fifth side surface 223b extending from one end of the fourth side surface 223a, and a sixth side surface 223c extending from the other end of the fourth side surface 223a. In an embodiment, the second side member 223 may be formed in a rectangular shape through the fourth side surface 223a, the fifth side surface 223b, and the sixth side surface 223c.

According to various embodiments, the first and second housings 210 and 220 are not limited to the illustrated forms and couplings, but may be implemented by other shapes or combinations and/or couplings of components. In an embodiment, the first side member 213 may be formed integrally with the first rear cover 214, and the second side member 223 may be formed integrally with the second rear cover 224.

According to various embodiments, in the unfolded state of the electronic device 101, the second side surface 213b of the first side member 213 and the fifth side surface 223b of the second side member 223 may be connected without a gap. In an embodiment, in the unfolded state of the electronic device 101, the third side surface 213c of the first side member 213 and the sixth side surface 223c of the second side member 223 may be connected without a gap. In an embodiment, in the unfolded state of the electronic device 101, the combined length of the second side surface 213b and the fifth side surface 223b may be configured to be greater than the length of the first side surface 213a and/or the fourth side surface 223a. In an embodiment, in the unfolded state of the electronic device 101, the combined length of the third side surface 213c and the sixth side surface 223c may be configured to be longer than the length of the first side surface 213a and/or the fourth side surface 223a.

Referring to FIGS. 3A and 3B, a first side member 213 and/or a second side member 223 may be formed of a metal, or may further include a polymer injection-molded onto the metal. In an embodiment, the first side member 213 and/or the second side member 223 may include at least one conductive portion 216 and/or 226 that is electrically segmented through at least one segmented portion 2161, 2162, and/or 2261, 2262 made of a polymer. In this case, the at least one conductive portion 216 and/or 226 may be used as at least a part of an antenna that operates in a designated at least one band (e.g., a legacy band or a new radio (NR) band) by being electrically connected to a wireless communication circuit included in the electronic device 101.

According to various embodiments, the first rear cover 214 and/or the second rear cover 224 may be formed of, for example, at least one or a combination of at least two of coated or tinted glass, ceramic, polymer, or metal (e.g., aluminum, stainless steel (STS), or magnesium).

According to various embodiments, the first display 230 may be disposed to extend from the first surface 211 of the first housing 210 to at least a portion of the third surface 221 of the second housing 220 across a hinge device (e.g., the hinge assembly HA in FIG. 2B). In an embodiment, the first display 230 may include a first area 230a that substantially corresponds to the first surface 211, a second area 230b that corresponds to the second surface 212, and a third area 230c (e.g., a folding area or a bendable area) that connects the first area 230a and the second area 230b. In an embodiment, the third area 230c may be a portion of the first area 230a and/or the second area 230b, and may be positioned to correspond to the hinge device (e.g., the hinge assembly HA in FIG. 2B). In an embodiment, the electronic device 101 may include a hinge housing 241 (e.g., a hinge cover) that supports the hinge device (e.g., the hinge assembly HA in FIG. 2B). In an embodiment, the hinge housing 241 may be disposed such that, in the folded state of the electronic device 101, the hinge housing 241 is at least partially visually exposed to the outside and, in the unfolded state of the electronic device 101 is in a folded state, the hinge housing 241 is moved into the internal space of the first housing 210 and the internal space of the second housing 220 and thus is not visually visible from the outside.

According to various embodiments, the electronic device 101 may include a second display 231 (e.g., a sub-display) disposed separately from the first display 230. In an embodiment, the second display 231 may be disposed on the second surface 212 of the first housing 210 to be at least partially visually exposed. In an embodiment, in the folded state of the electronic device 101, the second display 231 may at least partially substitute for the display function of the first display 230 to display at least a portion of the status information of the electronic device 101. In an embodiment, the second display 231 may be disposed to be visible from the outside through at least a partial area of the first rear cover 214. In an embodiment, the second display 231 may also be disposed on the fourth surface 222 of the second housing 220. In this case, the second display 231 may be disposed so as to be visible from the outside through at least a partial area of the second rear cover 224.

According to various embodiments, the electronic device 101 may include at least one of an input device 203 (e.g., a microphone), sound output devices 201 and 202, a sensor module 204, camera devices 205 and 208, a key input device 206, or a connector port 207. In the illustrated embodiment, the input device 203 (e.g., a microphone), the sound output devices 201 and 202, the sensor module 204, the camera devices 205 and 208, the key input device 206, or the connector port 207 is illustrated as a hole or circular element formed in the first housing 210 or the second housing 220. However, this is an illustration for description, and the disclosure is not limited thereto. According to various embodiments, the input device 203 may include at least one microphone 203 disposed in the second housing 220. In an embodiment, the input device 203 may include multiple microphones 203 configured to detect the direction of sounds. In an embodiment, the multiple microphones 203 may be disposed at appropriate locations in the first housing 210 and/or the second housing 220. In an embodiment, the sound output devices 201 and 202 may include at least one speaker 201 and 202. In an embodiment, the at least one speaker 201 and 202 may include a call receiver 201 disposed in the first housing 210 and a speaker 202 disposed in the second housing 220. In an embodiment, the input device 203, the sound output devices 201 and 202, and the connector port 207 may be disposed in a space provided in the first housing 210 and/or the second housing 220 of the electronic device 101, and may be exposed to the external environment through at least one hole formed in the first housing 210 and/or the second housing 220. In an embodiment, the at least one connector port 207 may be used to transmit/receive power and/or data with an external electronic device. In an embodiment, the at least one connector port (e.g., an ear jack hole) may accommodate a connector (e.g., an ear jack) for transmitting/receiving audio signals with an external electronic device. In an embodiment, the hole formed in the first housing 210 and/or the second housing 220 may be used in common for the input device 203 and the sound output devices 201 and 202. In an embodiment, the sound output devices 201 and 202 may include a speaker (e.g., a piezoelectric speaker) that is not exposed through a hole formed in the first housing 210 and/or the second housing 220.

According to various embodiments, the sensor module 204 may generate an electrical signal or a data value corresponding to the internal operating state of the electronic device 101, or external environmental states. In an embodiment, the sensor module 204 may detect external environments through the first surface 211 of the first housing 210. In an embodiment, the electronic device 101 may further include at least one sensor module disposed to detect external environments through the second surface 212 of the first housing 210. In an embodiment, the sensor module 204 (e.g., an illuminance sensor) may be disposed under the first display 230 so as to detect external environments through the first display 230. In an embodiment, the sensor module 204 may include at least one of a gesture sensor, a gyro sensor, a barometric pressure sensor, a magnetic force sensor, an acceleration sensor, a grip sensor, a color sensor, an infrared (IR) sensor, a biometric sensor, a temperature sensor, a humidity sensor, an illuminance sensor, a proximity sensor, a biometric sensor, an ultrasonic sensor, or an illuminance sensor.

According to various embodiments, the camera devices 205 and 208 may include a first camera device 205 (e.g., a front camera device) disposed on the first surface 211 of the first housing 210 and a second camera device 208 disposed on the second surface 212 of the first housing 210. In an embodiment, the electronic device 101 may further include a flash 209 disposed near the second camera device 208. In an embodiment, the first camera device 205 or the second camera device 208 may include at least one lens, an image sensor, and/or an image signal processor. In an embodiment, the camera devices 205 and 208 may be disposed such that two or more lenses (e.g., wide-angle lenses, ultra-wide-angle lenses, or telephoto lenses) and two or more image sensors are positioned on one surface (e.g., the first surface 211, the second surface 212, the third surface 221, or the fourth surface 122) of the electronic device 101. In an embodiment, the first camera device 205 and the second camera device 208 may include lenses for time of flight (TOF) and/or image sensors.

According to various embodiments, the key input device 206 (e.g., a key button) may be disposed on the third side surface 213c of the first side member 213 of the first housing 210. In an embodiment, the key input device 206 may also be disposed on at least one of the other side surfaces 213a and 213b of the first housing 210 and/or the side surfaces 223a, 223b, and 223c of the second housing 220. In an embodiment, the electronic device 101 may not include some or all of key input devices 206, and the key input devices 206 not included may be implemented in another form, such as a soft key, on the first display 230. In an embodiment, the key input device 206 may also be implemented by using a pressure sensor included in the first display 230.

According to various embodiments, some camera devices (e.g., the first camera device 205) among the camera devices 205 and 208 or the sensor module 204 may be disposed so as to be visually exposed through the first display 230. In an embodiment, the first camera device 205 or the sensor module 204 may be optically exposed to the outside through an opening (e.g., a through-hole) at least partially formed in the first display 230, in the internal space of the electronic device 101. In an embodiment, at least a portion of the sensor module 204 may be disposed such that the same is not visually exposed through the first display 230 in the internal space of the electronic device 101. Referring to FIG. 3B, the electronic device 101 may operate to maintain at least one designated folding angle in an intermediate state through the hinge device (e.g., the hinge assembly HA in FIG. 2B). For example, the electronic device 101 may control the first display 230 so that different contents are displayed in the display area corresponding to the first surface 211 and in the display area corresponding to the third surface 221. In an embodiment, the electronic device 101 may operate in a substantially unfolded state (e.g., the unfolded state in FIG. 2A) and/or a substantially folded state (e.g., the folded state in FIG. 3A), with reference to a specific folding angle (e.g., the angle between the first housing 210 and the second housing 220 when the electronic device 101 is in the intermediate state) through the hinge device (e.g., the hinge assembly HA in FIG. 2B). In an embodiment, the electronic device 101 may operate to transition to the unfolded state (e.g., the unfolded state in FIG. 2A) in case that a pressing force is applied in the unfolding direction (direction A), while the same is unfolded at a specific folding angle, through the hinge device (e.g., the hinge assembly HA in FIG. 2B). In an embodiment, the electronic device 101 may operate to transition to the folded state (e.g., the folded state in FIG. 3A) in case that a pressing force is applied in the folding direction (direction B), while the same is unfolded at a specific folding angle, through the hinge device (e.g., the hinge assembly HA in FIG. 2B). In an embodiment, the electronic device 101 may operate to maintain a state (not shown) in which the same is unfolded at various folding angles through the hinge device (e.g., the hinge assembly HA in FIG. 2B) (free stop function).

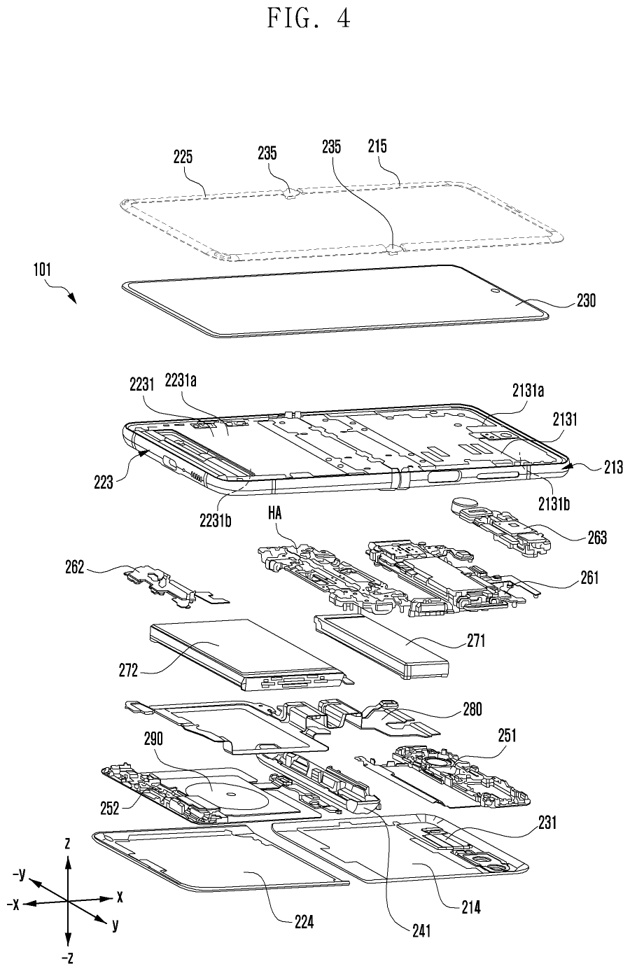

FIG. 4 is an exploded perspective view of an electronic device according to an embodiment of the disclosure.

Referring to FIG. 4, an electronic device 101 may include a first side member 213 (e.g., a first side frame), a second side member 223 (e.g., a second side frame), and a hinge assembly HA (e.g., the hinge assembly HA in FIG. 2B) (e.g., a hinge device, a hinge module, or a hinge structure) rotatably connecting the first side member 213 and the second side member 223. In an embodiment, the electronic device 101 may include a first support member 2131 (e.g., a first support plate) extending at least partially from the first side member 213, and a second support member 2231 (e.g., a second support plate) extending at least partially from the second side member 223. In an embodiment, the first support member 2131 may be formed integrally with the first side member 213 or structurally coupled to the first side member 213. In an embodiment, the second support member 2231 may be formed integrally with the second side member 223 or may be structurally coupled to the second side member 223. In an embodiment, the first display 230 may be disposed to be supported by the first support member 2131 and the second support member 2231. In an embodiment, the electronic device 101 may include a first rear cover 214 coupled to the first side member 213 so as to provide a first space between the same and the first support member 2131, and a second rear cover 224 coupled to the second side member 223 so as to provide a second space between the same and the second support member 2231. In an embodiment, the first side member 213 and the first rear cover 214 may be formed integrally. In an embodiment, the second side member 223 and the second rear cover 124 may be formed integrally. In an embodiment, the first housing 210 may include a first side member 213, a first support member 2131, and the first rear cover 214. In an embodiment, the second housing 220 may include a second side member 223, the second support member 2231, and the second rear cover 224. In an embodiment, the electronic device 101 may include a second display 231 disposed to be visible from the outside through at least a portion of the first rear cover 214.

According to various embodiments, the electronic device 101 may include a first substrate 261 (e.g., a first substrate assembly or a main printed circuit board) disposed in the first space between the first side member 213 and the first rear cover 214, a camera assembly 263, a first battery 271, or a first bracket 251. In an embodiment, the camera assembly 263 may include multiple camera devices (e.g., the camera devices 205 and 208 in FIGS. 2A and 3A) and may be electrically connected to the first substrate 261. In an embodiment, the first bracket 251 may provide a support structure for supporting the first substrate 261 and/or the camera assembly 263, and improved rigidity. In an embodiment, the electronic device 101 may include a second substrate 262 (e.g., a second substrate assembly or a sub-printed circuit board) disposed in the second space between the second side member 223 and the second rear cover 224, an antenna 290 (e.g., a coil member), a second battery 272, or a second bracket 252. In an embodiment, the electronic device 101 may include a wiring member 280 (e.g., a flexible printed circuit board (FPCB)) disposed to extend from the first substrate 261, across the hinge assembly HA, to multiple electronic components (e.g., the second substrate 262, the second battery 272, or the antenna 290) disposed between the second side member 223 and the second rear cover 224, thereby providing electrical connection. In an embodiment, the antenna 290 may include a near field communication (NFC) antenna, a wireless charging antenna, and/or a magnetic secure transmission (MST) antenna.

According to various embodiments, the electronic device 101 may include a first protective cover 215 (e.g., a first protective frame or a first decorative member) coupled along the edge of the first housing 210, and a second protective cover 225 (e.g., a second protective frame or a second decorative member) coupled along the edge of the second housing 220. In an embodiment, the first protective cover 215 and/or the second protective cover 225 may be formed of a metal or polymer material. In an embodiment, the first protective cover 215 and/or the second protective cover 225 may be used as decoration members. In this case, the first display 230 may be disposed such that the edge of the first area (e.g., the first area 230a in FIG. 2B) is not visible from the outside between the first housing 210 and the first protective cover 215. In an embodiment, the first display 230 may be disposed such that the edge of the second area (e.g., the second area 230b in FIG. 2B) is not visible from the outside between the second housing 220 and the second protective cover 225. In some embodiments, the first protective cover 215 and/or the second protective cover 225 may be omitted.

According to various embodiments, the electronic device 101 may also include a protective structure 135 disposed to protect the edge of the third area (e.g., the third area 230c in FIG. 2B) of the first display 230. In this case, the first display 230 may have a protective structure 235 positioned to correspond to the folding area (e.g., the folding area 230c in FIG. 2B) such that the edge of the first display 230 is protected. In some embodiments, the protective structure 235 may be omitted.

According to various embodiments, the first support member 2131 may include a first support surface 2131a facing in the first direction (the z-axis direction) and a second support surface 2131b facing in a second direction (−z-axis direction) opposite to the first direction. In an embodiment, the second support member 2231 may include a third support surface 2231a facing in the first direction (z-axis direction) and a fourth support surface 2231b facing in the second direction (−z-axis direction), in the unfolded state of the electronic device 101. In an embodiment, the first display 230 may be disposed to be supported by the first support surface 2131a of the first support member 2131 and the third support surface 2231a of the second support member 2231.

FIG. 5 is a diagram illustrating the arrangement of a magnetic force sensor, magnetic bodies, and a folding angle sensor included in an electronic device according to an embodiment of the disclosure.

The electronic device 101 according to an embodiment may be a foldable electronic device including a first housing 210 and a second housing 220 connected to the first housing 210 such that the same can be opened or closed, as illustrated in FIGS. 2A to 2C, 3A, 3B, and 4. For example, the electronic device 101 may include all or at least some of the components of the electronic device 101 described above with reference to FIGS. 2A to 2C, 3A, 3B, and 4.

Referring to FIG. 5, according to an embodiment, an electronic device 101 may include a magnetic force sensor 520 (e.g., a Hall sensor) configured to detect whether the device is in a folded state, magnetic bodies M1 (511), M2 (512), M3 (513), and M4 (514) for fixing the first housing 210 and the second housing 220, a first folding angle sensor 530 (e.g., a 6-axis sensor) and a second folding angle sensor 535 (e.g., a 6-axis sensor) configured to calculate the folding angle.

The first housing 210 and the second housing 220 may maintain the folded state through the attractive force acting between the magnets in the folded state. For example, the first housing 210 may have a first magnet M1 and a second magnet M2 disposed therein, and the second housing 220 may have a third magnet M3 and a fourth magnet M4 disposed therein. In the closed state of the electronic device 101, the first magnet M1 511 and a second magnet M2 512 may be disposed to at least partially face each other, and a third magnet M3 513 and a fourth magnet M4 514 may be disposed to at least partially face each other, thereby exerting the attractive force.

In an embodiment, the magnetic force sensor 520 may be positioned adjacent to the second magnet M2 512, but is not limited thereto. In the example of FIG. 5, the second magnet M2 512 or the first magnet M1 511 may continuously or fixedly supply a magnetic force to the magnetic force sensor 520, and the fourth magnet M4 514 or the third magnet M3 513 may vary in distance from the magnetic force sensor 250 according to the open/closed state of the electronic device 101, thereby supplying additional magnetic force and magnetic flux values to the magnetic force sensor.

According to an embodiment, the electronic device 101 may determine the opening/closing state (e.g., open state/closed state) of the electronic device 101, based on a change in the magnetic force measured by the magnetic force sensor 520. For example, the electronic device 101 may configure a first recognition condition (e.g., about 0 μT) for determining the open state of the electronic device 101 in relation to the magnetic force value, and a second recognition condition for determining the closed state (e.g., in case that the magnetic force is about 3000 μT in the closed state, the closed state is recognized if the magnetic force is above about 2100 μT).

In case that the change in the magnetic force measured by the magnetic force sensor 520 satisfies the first recognition condition, the magnetic force sensor 520 may output an interrupt signal indicating the closed state, and in case that the change in the magnetic force measured by the magnetic force sensor 520 satisfies the second recognition condition, the magnetic force sensor 520 may output an interrupt signal indicating the open state.

The electronic device 101 may recognize the opened/closed state of the electronic device 101 in response to the interrupt signal transferred from the magnetic force sensor 520.

However, in the case of the electronic device illustrated in FIG. 5, the magnetic force value from the magnetic force sensor 520 may change even if an external magnetic body other than the fourth magnet M4 514 approaches the second magnet M2 512 located near the magnetic force sensor 520 of the electronic device 101, thereby satisfying the magnetic force condition in the closed state. As a result, the electronic device 101 may erroneously recognize that the electronic device 101 is in a closed state, although the electronic device 101 is in an open state, due to the external magnetic body, and this may lead to erroneous operations of the electronic device.

The following description of various embodiments will be directed to a method and a device wherein, in addition to magnetic force sensors, folding angle sensors configured to calculate the folding angle are used to monitor (or determine) whether a change in the magnetic force is an intended change or an unintended change, preventing erroneous operations based on electronic device opening/closing recognition, in conjunction with illustration of structures for the electronic device opening/closing recognition.

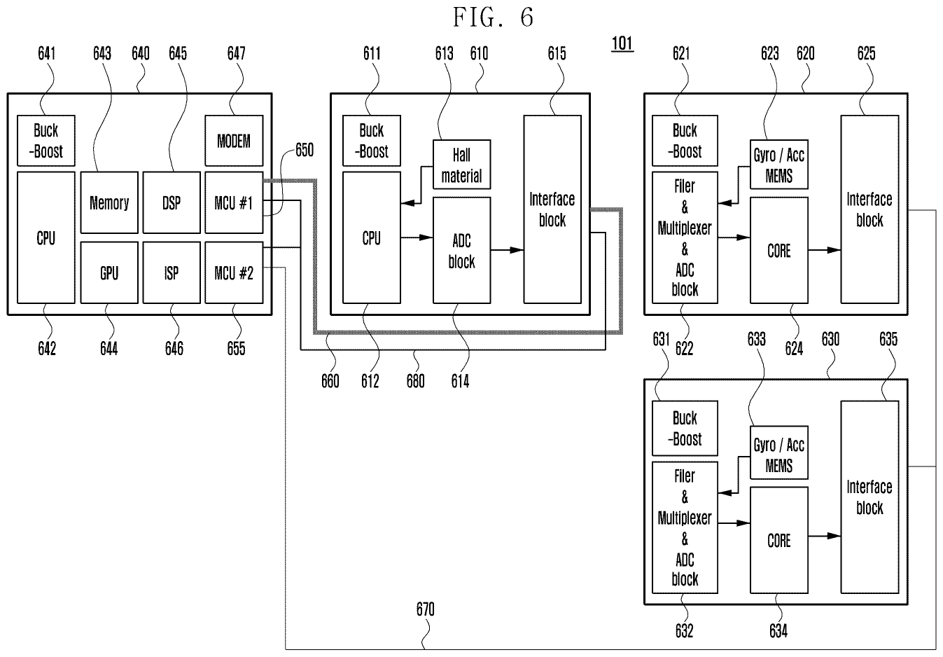

FIG. 6 illustrates components of the electronic device opening/closing recognition structure according to an embodiment of the disclosure.

Referring to FIG. 6, an electronic device 101 according to an embodiment may be a foldable electronic device including a first housing 210 and a second housing 220 connected to the first housing 210 such that the same can be opened or closed, as illustrated in FIGS. 2A to 2C, 3A, 3B, and 4.

The electronic device 101 may include a magnetic force sensor 610 (e.g., the magnetic force sensor 520 in FIG. 5), a first folding angle sensor 620 (e.g., the first folding angle sensor 530 in FIG. 5), a second folding angle sensor 630 (e.g., the second folding angle sensor 535 in FIG. 5), and a processor 640 (e.g., the processor 120 in FIG. 1). The components shown in FIG. 6 are merely examples, and the electronic device 101 may further include at least some of the components and functions in FIGS. 1, 2A to 2C, 3A, 3B, and 4, in addition to the illustrated components.

According to an embodiment, the magnetic force sensor 610 may be designed for the purpose of determining whether the electronic device 101 is in a folded state. The first folding angle sensor 620 and the second folding angle sensor 630 may be designed to determine the folding angle for user interface (UI) switching corresponding to the display shape.

In the disclosure, the first folding angle sensor 620 and the second folding angle sensor 630 may be additionally designed for monitoring (or determining) the folded state, to determine whether a change in magnetic force is an intended change or an unintended change.

According to an embodiment, the magnetic force sensor 610 may be connected to the processor 640 or the first microcontroller unit (MCU) 650 through a first data line 660 for transmitting magnetic force values (e.g., magnet data) from the magnetic force sensor and an interrupt line (or a signal line) 680 for transmitting an interrupt signal in case that a magnetic force condition is satisfied based on the state of the electronic device 101, and may be connected to a second MCU 655 through a line that branches off from a node of the interrupt line 680.

The magnetic force sensor 610 may recognize changes in the magnetic force/magnetic field generated between a magnetic body (e.g., an object having a magnetic force) (e.g., the second magnet and/or the fourth magnet in FIG. 5). For example, the magnetic force sensor 610 may measure (or sense/detect) a magnetic force value (e.g., magnetic force data/magnetic field strength) based on magnetic materials moving toward or away from the same, and may transfer the measured magnetic value to the first MCU 650 through the first data line 660.

The magnetic force sensor 610 may output an interrupt signal to the first MCU 650 and the second MCU 655 through the interrupt line according to whether a magnetic force change in the magnetic force value satisfies (or corresponds to) the open/closed state recognition condition. For example, in case that a magnetic force change in the magnetic force value satisfies (or corresponds to) a first recognition condition indicating a change from a first state to a second state, the magnetic force sensor 610 may output (or transfer) a first interrupt signal to the first MCU 650 and the second MCU 655 through the interrupt line 680. In case that a magnetic force change in the magnetic value satisfies (or corresponds to) a second recognition condition indicating a change from the second state to the first state, the magnetic force sensor 610 may output (or transfer) a second interrupt signal to the first MCU 650 and the second MCU 655.

According to an embodiment, the magnetic force sensor 610 (e.g., a Hall IC) may be implemented as a digital Hall sensor. In case that the magnetic force sensor 610 is implemented as a digital Hall sensor, the configuration of the magnetic force sensor 610 may include at least one of a converter (e.g., a buck-boost converter) 611 which converts an external voltage to an internal voltage, a Hall element (or Hall material) 613 which causes a Hall effect (a phenomenon in which, when a current flows through a conductor, and when a magnetic field is formed perpendicular to the direction of the current, a potential difference is generated in the conductor in which the current flows in a direction perpendicular to the current), a CPU 612 which transfers an axis-specific voltage value transferred from the Hall element 613 or calculates data, an analog-digital converter (ADC) 614 which converts an analog signal to a digital signal, and/or an interface block 615.

According to an embodiment, in case that the magnetic force sensor 610 is a digital Hall sensor, open/closed state recognition conditions (e.g., a first recognition condition and a second recognition condition) may be configured based on the magnetic force value of one axis which exhibits a significant change in the magnetic force value according to the open/closed state of the electronic device 101, among the x-axis, y-axis, and z-axis. The recognition conditions may also be referred to as reference conditions, reference values, or threshold values.

In case that a recognition condition is satisfied according to a magnetic force change along one configured axis, the magnetic force sensor 610 may output an interrupt signal to the first MCU 650 and the second MCU 655 through the interrupt line 680.

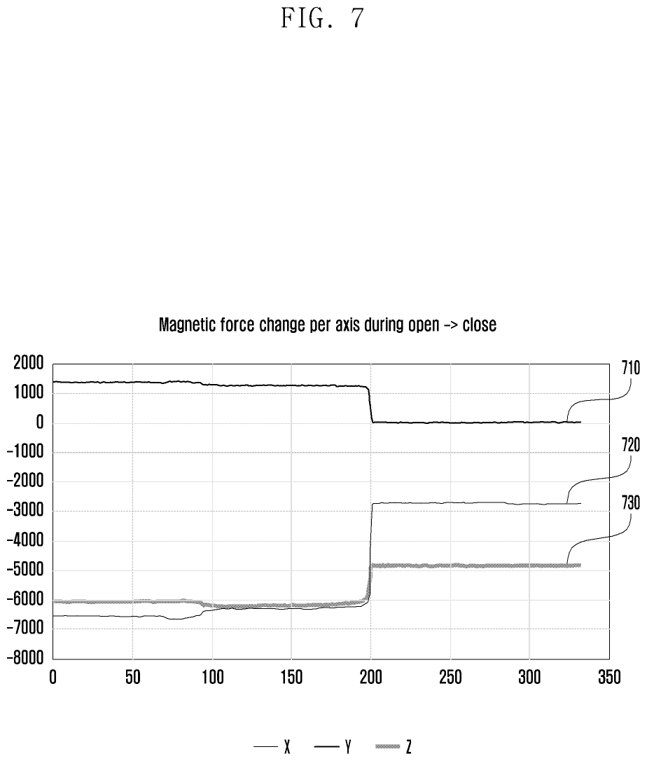

FIG. 7 illustrates a graph showing a change in the magnetic force according to a folding angle when an electronic device transitions from an open state to a closed state according to an embodiment of the disclosure.

Referring to FIG. 7, it is clear from the graph in FIG. 7 that the x-axis 720 exhibits the largest difference in the magnetic force change among those corresponding to the x-axis 720, the y-axis 710, and the z-axis 730. The difference (delta) in the magnetic force change in this regard is as shown in Table 1. For example, the x-axis may be an axis along which housings of an electronic device are folded as in the case of the electronic device shown in FIGS. 2A to 2C, the y-axis may be an axis that is perpendicular to the x-axis on a plane, and the z-axis may be an axis that is perpendicular to the x-axis in space. The unit of the magnetic force value may be μT, but is not limited thereto.

TABLE 1

Magnetic force change during opening/closing

| uT | X | Y | Z |
|---|---|---|---|
| open | −6540 | 1395 | −6054 |
| close | −2740 | 41 | −4839 |
| delta | 3800 | −1354 | 1215 |

As shown in FIG. 7 and Table 1, it is clear that the X-axis is the one axis that exhibits a large difference in the magnetic force during a state change of the electronic device 101 (from the open state to the closed state). The electronic device 101 may configure a first recognition condition (or a first reference value) for determining the closed state of the electronic device and a second recognition condition (or a second reference value) for determining the open state thereof, with reference to the range and aspect of the magnetic force along the x-axis. In an embodiment, since the first recognition condition and the second recognition condition may be configured for each axis, the same may be configured with reference to the axis that exhibits a large difference in the magnetic force according to the folding direction of the electronic device 101. It will be assumed in the following description, for example, that the open/closed state recognition condition is configured based on the magnetic force value corresponding to the x-axis, but the open/closed state recognition condition may also be configured based on the magnetic force value corresponding to the x-axis or the z-axis.

According to an embodiment, the electronic device 101 may be configured such that, in addition to the first axis configured in connection with open/closed state recognition conditions (e.g., a first reference value and a second reference value), the change pattern (or the range and aspect) of the second axis and the third axis other than the same are used for open/closed state monitoring. For example, the electronic device 101 may identify whether an approaching magnetic material is an external magnetic material, based on the change pattern of the magnetic force value along the x-axis, y-axis, and z-axis.

According to an embodiment, the magnetic force sensor 610 may transfer measured magnetic force values, that is, magnetic force values along the x-axis, y-axis, and z-axis, to the first MCU 650 through the first data line 660. Based on an interrupt signal being received through the interrupt line, the first MCU 650 may compare the change pattern (or range and aspect) second and third axes other than the first axis along which open/closed state recognition conditions (e.g., first and second reference values) are configure with magnetic force changes stored in the memory (e.g., change data of the y-axis and z-axis om FIG. 7 and Table 1), thereby determining whether the magnetic force along the two axes (e.g., the second and third axes other than the configured first axis) is similar to the current magnetic force change. In case that the current two axes' magnetic force changes do not have similar aspects, or in case that the magnetic force values of the second and third axes do not satisfy the second state recognition conditions, the first MCU 650 may recognize an unintended magnetic force change caused by an external magnetic body approaching the two axes, and may request the second MCU 655 to calculate the folding angle. In response to an interrupt signal being received, the second MCU 655 may activate (or turn on) at least one of the first folding angle sensor 620, the second folding angle sensor 630, and an angle calculation processing unit (not shown) (or angle calculation module/angle calculation core). For example, the angle calculation processing unit may be at least a partial core, block, or element included in the second MCU 655, but is not limited thereto. The first folding angle sensor 620 or the second folding angle sensor 630 may, under the control of the second MCU 655, measure angular velocity changes and acceleration changes related to movements of the electronic device 101, or may measure changes in the folding angle and transmit the measured data (e.g., acceleration/angular velocity data) to the processor 640 or the second MCU 655 through a second data line 670. For example, the electronic device 101 may include a first folding angle sensor 620 in the first housing 210 and a second folding angle sensor 630 in the second housing 220. The first folding angle sensor 620 may detect angular velocity changes and acceleration changes related to movements of the electronic device 101, and the second folding angle sensor 630 may measure (or detect/sense/identify) angular velocity changes and acceleration changes related to movements of the second housing 220.

The first folding angle sensor 620 or the second folding angle sensor 630 (e.g., a 6-axis sensor) may be configured as a combination of at least two of an acceleration sensor, an angular velocity sensor (e.g., a gyroscope sensor), or a geomagnetic sensor. The acceleration sensor may be a sensor that detects the velocity of an object, and the gyroscope sensor may detect the angular velocity (rotational velocity) of an object. The geomagnetic sensor may detect the geomagnetic direction of an object.

For example, the first folding angle sensor 620 may include a converter (e.g., a buck-boost converter) 621 which converts an external voltage to an internal voltage, a gyro/acceleration structure 623, a block (e.g., a filter, a multiplexer, and an ADC converter) 622 which processes data from the gyro/acceleration structure 623, a computing block (e.g., a core) 624, and/or an interface block 625. The second folding angle sensor 630 may include a converter (e.g., a buck-boost converter) 631 which converts an external voltage to an internal voltage, a gyro/acceleration structure 633, a block (e.g., a filter, a multiplexer, and an ADC converter) 632 which processes data from the gyro/acceleration structure 633, a computing block (e.g., a core) 634, and/or an interface block 635. However, this is merely an example.

According to an embodiment, the processor 640 may control the driving of the magnetic force sensor 610, the first folding angle sensor 620, and the second folding angle sensor 630, and may recognize opening/closing information (e.g., the open/closed state and/or the folding angle) of the electronic device 101, based on data acquired from at least one of the magnetic force sensor 610, the first folding angle sensor 620, and/or the second folding angle sensor 630. The processor 640 may be identical to the main processor 121 or the application processor (AP) in FIG. 1, or may be included in the main processor 121 in FIG. 1.

According to an embodiment, the processor 640 may recognize the open or closed state of the electronic device 101 through the first MCU 650 and the second MCU 655, and may control the operation of the electronic device 101, based on the open/closed state of the electronic device 101.

According to an embodiment, the processor 640 may include one or more processing units (or processing cores/processing blocks) to process respective components of the electronic device 101.

In an embodiment, the processor 640 may include a first microcontroller unit (MCU) 650 which is operated in the active state of the electronic device 101 (e.g., a state in which the electronic device 101 is powered on, and the display is turned on), or in the operating state after booting, and a second MCU 655 which is operated in a power-off state in which a charger electrically connected, a sleep state of the electronic device, or a low-power state before booting. In the case of a foldable electronic device, the active area of the display for displaying visual information or a screen is determined based on the recognized open/close state or folding angle, and the first MCU 650 and the second MCU 655 may thus be implemented as essential components.

Although the first MCU 650 and the second MCU 655 are implemented as being included in the processor 640 in the example of FIG. 6, at least one of the first MCU 650 and the second MCU 655 may be implemented as a separate component from the processor 640.

The first MCU 650 may acquire a magnetic force value (e.g., magnetic force data) measured by the magnetic force sensor 610 through the first data line 660. The first MCU 650 may determine the open/closed state of the electronic device, based on an interrupt signal output from the magnetic force sensor 610 through the interrupt line (or signal line) 680.

In response to receiving an interrupt signal output from the magnetic force sensor 610 through the interrupt line (or signal line) 680, the second MCU 655 may activate the first folding angle sensor 620 and the second folding angle sensor 630 (e.g., an angle calculation processing unit, and/or a gyro sensor) and may acquire data (e.g., acceleration/angular velocity data) measured from the first folding angle sensor 620 and the second folding angle sensor 630 through the second data line 670. In this embodiment, the second MCU 655 may control operations of the first folding angle sensor 620 and the second folding angle sensor 630, instead of a high-performance processing core such as an AP or a CPU.

Additionally, the processor 640 may further include a converter (e.g., a buck-boost converter) 641 which convers an external voltage to an internal voltage of each component in the processor, a central processing unit (CPU) 642, a graphics processing unit (GPU) 644, a digital signal processor (DSP) 645, an image signal processor (ISP) 646, a modem processor 647, and memory 643. However, this is merely an example and is not limitative. According to an embodiment, the processing units within the processor 640 may be implemented as independent devices, or may be integrated into a single processor.

In the case of the comparative embodiment (or conventional case), if the first MCU 650 receives an interrupt signal from the magnetic force sensor in relation to opening/closing recognition, a message regarding the state the electronic device 101 is transferred to a high-performance core such as an AP or a CPU, and the high-performance core performs folding angle calculation by controlling the second MCU 655. Unlike such a sequence, the disclosure adopts a structure in which an interrupt signal from the magnetic force sensor is output to the second MCU 655 such that, through the folding angle calculation, opening/closing recognition operation error monitoring may be performed without delay.

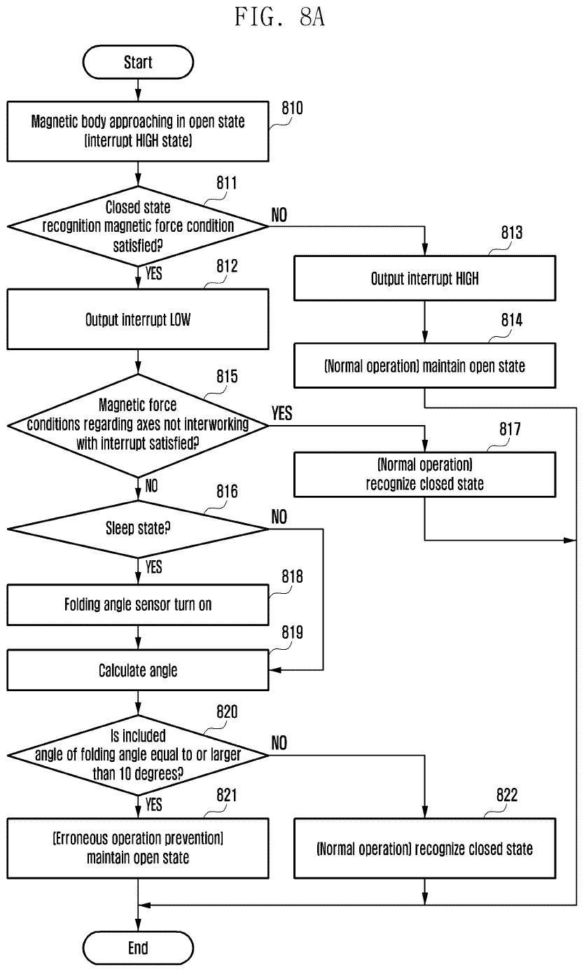

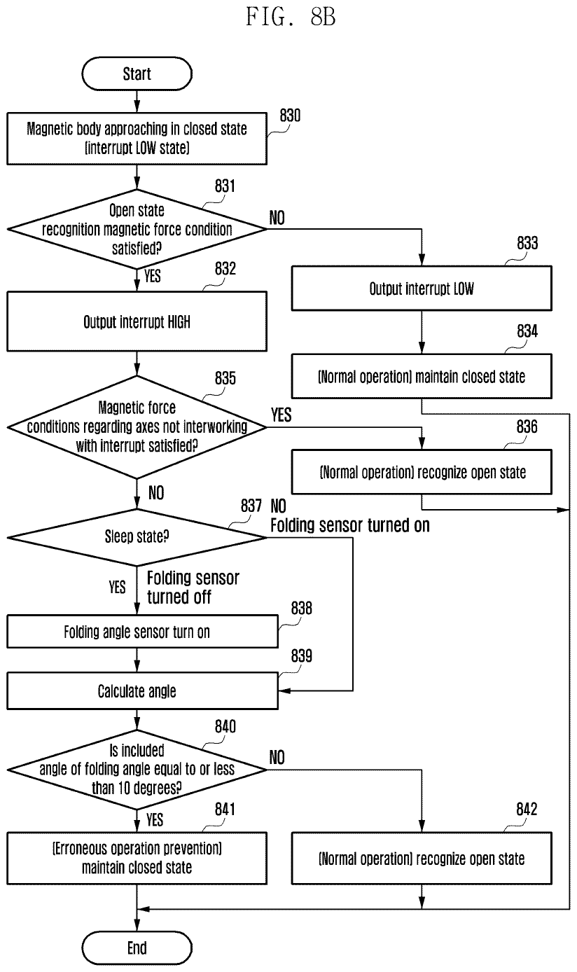

FIGS. 8A and 8B are flowcharts of a method for preventing open/closed state recognition erroneous operations of an electronic device including a magnetic force sensor according to various embodiments of the disclosure. FIG. 8A may represent an opening/closing recognition process in the open state of the electronic device, and FIG. 8B may represent an opening/closing recognition process in the closed state of the electronic device.

In the following embodiments, respective operations may be sequentially performed, but are not necessarily performed in a sequential manner. For example, the order respective operations may be changed, and at least two operations may be performed in parallel.

Referring to FIG. 8A, an electronic device 101 according to an embodiment includes the components in FIG. 6, and in operation 810, may detect the approach of a magnetic body in the electronic device's open state (or in the unfolded state of the first housing 210 and the second housing 220). For example, the magnetic force sensor (e.g., the magnetic force sensor 520 in FIG. 5 or the magnetic force sensor 610 in FIG. 6) may detect a change in the magnetic force value caused by the approaching magnetic body.

In the open state of the electronic device, the magnetic force sensor 610 may output an interrupt high signal indicating the first state to the first MCU 650 and the second MCU 655 through the interrupt line. The processor (e.g., the processor 120 in FIG. 1 or the processor 640 in FIG. 6) or the first MCU 650 may recognize the electronic device as being in an open state by means of the interrupt high signal. In an example, the interrupt signal indicating the open state is a high signal, and the interrupt signal indicating the closed state is a low signal, but the disclosure is not limited thereto.

In operation 811, the magnetic force sensor 610 of the electronic device 101 may determine whether the measured change in magnetic force satisfies a first-axis magnetic force condition (e.g., a first recognition condition/a first reference value) configured to identify the closed state.

For example, the magnetic force sensor 610 may measure the magnetic values along the x-axis, y-axis, and z-axis, and may transmit the magnetic data (e.g., the magnetic values along the x-axis, y-axis, and z-axis) to the first MCU 650.

The electronic device 101 may be configured to output an interrupt signal based on a change in magnetic force along one axis, and may be designed to output the interrupt signal according to the magnetic force recognition condition regarding the reference axis. For example, in case that the change in magnetic force regarding one axis satisfies a magnetic force condition configured for open/closed state recognition, the magnetic force sensor 610 may output an interrupt signal through the interrupt line 680, and the magnetic data (e.g., x-axis, y-axis, and z-axis magnetic values) may be transferred to the processor 640 or the first MCU 650 through the first data line 660.

In operation 812, in case that the magnetic force condition (e.g., first recognition condition) configured for closed state recognition is satisfied (yes in operation 811), the magnetic force sensor 610 of the electronic device 101 may output a low signal as an interrupt signal indicating the closed state.

In operation 813, in case that the magnetic force condition (e.g., first recognition condition) configured for closed state recognition is not satisfied (no in operation 811), the magnetic force sensor 610 of the electronic device 101 may output a high signal as an interrupt signal indicating the open state. In operation 814, the processor 640 or the first MCU 650 of the electronic device 101 may maintain the opening/closing state of the electronic device 101 recognized as the open state by means of the high signal.

In operation 815, the processor 640 or the first MCU 650 of the electronic device 101 may determine whether a change in the magnetic force along a different second axis and/or third axis, which does not interwork with an interrupt, satisfies the magnetic force condition for the closed state.

For example, the electronic device 101 may pre-store geomagnetic force change data along the x-axis, y-axis, and z-axis according to changes in the state of the electronic device, and may compare the currently measured magnetic force change with the magnetic force change data stored in the memory, thereby determining whether the magnetic force change along one axis is an intended change or an unintended change.

In operation 816, in case that the magnetic force condition regarding the second axis and/or the third axis does not satisfy the magnetic force condition configured for closed state recognition (no in operation 815), the processor 640 or the first MCU 650 of the electronic device 101 may determine whether the electronic device 101 is in sleep state.

In operation 817, in case that the magnetic force condition regarding the second axis and/or the third axis satisfies the magnetic force condition configured for closed state recognition (yes in operation 815), the processor 640 or the first MCU 650 of the electronic device 101 may recognize the opening/closing state of the electronic device 101 as a closed state.

In this case, the electronic device 101 is recognized as being in the closed state with respect to the first axis, but the magnetic force change along the second and third axes is similar to the stored magnetic force change pattern (or range and aspect) in the closed state, and may thus considered as an intended magnetic force change (in other words, a magnetic force change caused by the attraction of magnetic bodies mounted inside the electronic device housing) and recognized as a normal operation (in other words, normally recognized as a closed state).

In operation 818, in case that the electronic device 101 is in a sleep state (yes in operation 816), the processor 640 or the first MCU 650 of the electronic device 101 may turn on (or activate) the folding angle sensor (and the angle calculation processing unit) and, in case that the electronic device 101 is not in a sleep state (no in operation 816), may skip operation 818 and proceed to operation 819.

In operation 819, the processor 640 or the second MCU 655 of the electronic device 101 may calculate the folding angle, based on data transferred from the folding angle sensor through the second data line 670.

In operation 820, the processor 640 or the second MCU 655 of the electronic device 101 may determine whether the included angle of the folding is 10 degrees or more.

In operation 821, in case that the included angle of folding is 10 degrees or more (yes in operation 820), the processor 640 or the second MCU 655 of the electronic device 101 may maintain the opening/closing state of the electronic device 101 recognized as the open state.

In this case, although a low signal indicating a closed state has been received, the folding angle satisfies the open state condition (not closed state), and the electronic device 101 may accordingly consider that the generated magnetic force change is an unintended change and maintain the electronic device state recognized as the open state, thereby preventing erroneous operations.

The processor 640 or the first MCU 650 may control the magnetic force sensor 610 to output a high signal as the interrupt signal, based on the electronic device state being recognized as the open state.

In operation 822, the processor 640 or the second MCU 655 of the electronic device 101 may recognize the opening/closing state of the electronic device 101 as a closed state in case that the included angle of folding is less than about 10 degrees (no in operation 820). The electronic device may finally recognize that the opening/closing state of the electronic device 101 is a closed state because the electronic device is recognized in a closed state by the magnetic force sensor, and since the folding angle also satisfies the closed state condition.

Referring to FIG. 8B, in operation 830, an electronic device 101 according to an embodiment includes may detect the approach of a magnetic body in the electronic device's closed state (or in the closed state of the first housing 210 and the second housing 220). For example, the magnetic force sensor 610 may detect a change in the magnetic force value caused by the approaching magnetic body.

In the closed state of the electronic device, the magnetic force sensor (e.g., Hall sensor) may output an interrupt low signal to the first MCU 650 and the second MCU 655 through the interrupt line. The processor 640 or the first MCU 650 may recognize the electronic device as being in a closed state by means of the low signal.

In operation 831, the magnetic force sensor 610 of the electronic device 101 may determine whether the measured change in magnetic force satisfies a first-axis condition (e.g., second recognition condition/second reference value) configured to identify the open state.

In operation 832, in case that the recognition condition configured for open state recognition is satisfied (yes in operation 831), the magnetic force sensor 610 of the electronic device 101 may output a high signal as an interrupt signal indicating the open state.

In operation 833, in case that the recognition condition configured for open state recognition is not satisfied (no in operation 831), the magnetic force sensor 610 of the electronic device 101 may output a low signal as an interrupt signal indicating the closed state. In operation 834, the processor 640 or the first MCU 650 of the electronic device 101 may maintain the opening/closing state of the electronic device 101 recognized as the closed state.

In operation 835, the processor 640 or the first MCU 650 of the electronic device 101 may determine whether the magnetic force condition regarding a different second axis and/or third axis, which does not interwork with an interrupt, satisfies the magnetic force condition for the closed state.

In operation 836, in case that the magnetic force condition regarding the second axis and/or the third axis satisfies the magnetic force condition configured for closed state recognition (yes in operation 835), the processor 640 or the first MCU 650 of the electronic device 101 may recognize the opening/closing state of the electronic device 101 as an open state.

In this case, the electronic device 101 is recognized as being in the open state with respect to the first axis, but the magnetic force change along the second and third axes is similar to the stored magnetic force change pattern (or range and aspect) in the open state, and may thus considered as an intended magnetic force change (in other words, a magnetic force change caused by the attraction of magnetic bodies mounted inside the electronic device housing) and recognized as a normal operation (in other words, normally recognized as an open state).

In operation 837, in case that the magnetic force condition regarding the second axis and/or the third axis does not satisfy the magnetic force condition configured for open state recognition (no in operation 835), the processor 640 or the first MCU 650 of the electronic device 101 may determine whether the electronic device 101 is in a sleep state.

In operation 838, in case that the electronic device 101 is in a sleep state (yes in operation 837), the processor 640 or the first MCU 650 of the electronic device 101 may turn on (or activate) the folding angle sensor (and the angle calculation processing unit) and, in case that the electronic device 101 is not in a sleep state (no in operation 837), may proceed to operation 839.

In operation 839, the processor 640 or the second MCU 655 of the electronic device 101 may calculate the folding angle, based on data transferred from the folding angle sensor.

In operation 840, the processor 640 or the second MCU 655 of the electronic device 101 may determine whether the included angle of the folding is about 10 degrees or less.

In operation 841, in case that the included angle of folding is about 10 degrees or less (yes in operation 840), the processor 640 or the second MCU 655 of the electronic device 101 may maintain the opening/closing state of the electronic device 101 recognized as the closed state.

In this case, although a high signal indicating an open state has been received, the folding angle satisfies the closed state condition (not open state), and the electronic device 101 may accordingly consider that the magnetic force change generated by the magnetic force sensor 610 is an unintended change and maintain the electronic device state recognized as the closed state, thereby preventing erroneous operations.

In operation 842, the processor 640 or the second MCU 655 of the electronic device 101 may recognize the opening/closing state of the electronic device 101 as an open state in case that the included angle of folding exceeds about 10 degrees (no in operation 840).

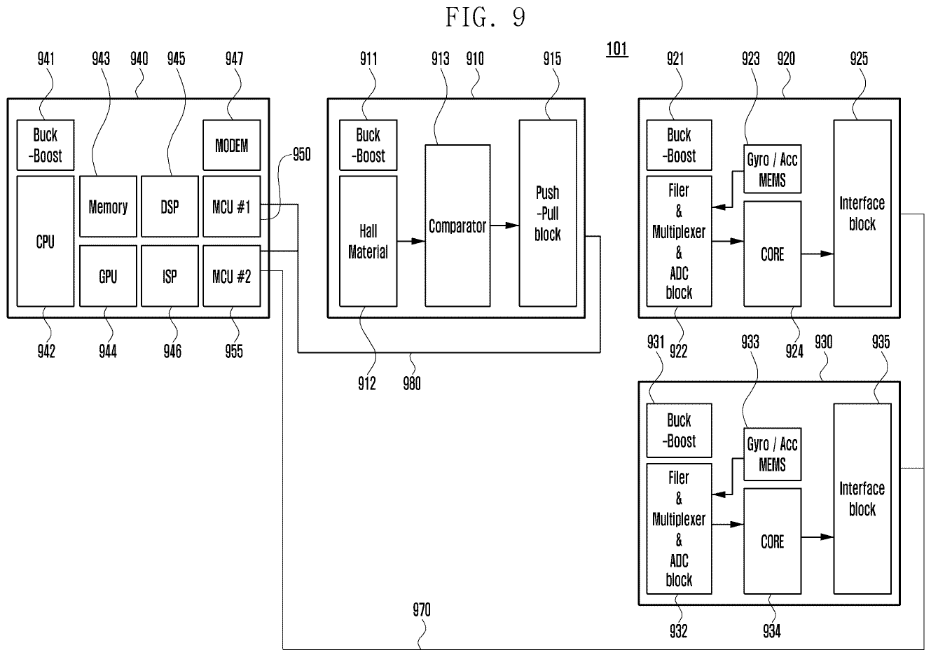

FIG. 9 illustrates components representing an electronic device's opening/closing recognition structure according to an embodiment of the disclosure.

Referring to FIG. 9, in an embodiment, a magnetic force sensor 910 may be implemented as an analog Hall sensor.

The embodiment in FIG. 6 illustrates an example in which the magnetic force sensor 610 is implemented as a digital Hall sensor, and the embodiment in FIG. 9 illustrates an example in which the magnetic force sensor 910 is implemented as an analog Hall sensor. Other components in FIG. 6 are substantially identical to those of FIG. 9, and thus detailed descriptions of the functions and components will be omitted herein. For example, the processor 940, the first folding angle sensor 920, and the second folding angle sensor 930 illustrated in FIG. 9 may be substantially identical to the processor 640, the first folding angle sensor 620, and the second folding angle sensor 630 illustrated in FIG. 6. In addition, the processing blocks (e.g., the converter 941 (e.g., buck-boost converter), the CPU 942, the memory 943, the GPU 944, the DSP 945, the ISP 946, the modem processor 947, the first MCU 950, and the second MCU 955) of the processor 940 may be substantially identical to the components in FIG. 6. In addition, the converter (e.g., a buck-boost converter) 921, the gyro/acceleration structure 923, the data processing block (e.g., a filter, a multiplexer, and an ADC converter) 922, the computing block (e.g., a core) 924, and the interface block 925 included in the first folding angle sensor 920 may be substantially identical to the converter (e.g., a buck-boost converter) 931, the gyro/acceleration structure 933, the data processing block (e.g., a filter, a multiplexer, and an ADC converter) 932, the computing block (e.g., a core) 934, and/or the interface block 935 included in the second folding angle sensor 930.

According to an embodiment, in case that the magnetic force sensor 910 is implemented as an analog Hall sensor, the magnetic force sensor 910 may be connected to each of the first MCU 950 and the second MCU 955 through an interrupt line 980, and the first data line 660 shown in FIG. 6 may be omitted. The second MCU 955 may be connected to the first folding angle sensor 920 and the second folding angle sensor 930 through a data line 970. According to an embodiment, in case that the magnetic force sensor 910 is implemented as an analog Hall sensor, the magnetic force sensor 910 may be connected to each of the first MCU 950 and the second MCU 955 through an interrupt line 980, and the first data line 660 shown in FIG. 6 may be omitted. The second MCU 955 may be connected to the first folding angle sensor 920 and the second folding angle sensor 930 through a data line 970. Unlike the digital Hall sensor 610 of FIG. 6, which includes a CPU 612 and an ADC 614 for internal digital processing and transmits multi-axis magnetic force data via the first data line 660, the analog Hall sensor 910 of FIG. 9 may generate an interrupt signal without providing multi-axis magnetic force data to the first MCU 950. Accordingly, in the embodiment of FIG. 9, since the analog Hall sensor 910 outputs a single-axis interrupt signal rather than multi-axis magnetic force data, the multi-axis magnetic force pattern verification described with reference to FIGS. 8A and 8B may be omitted, and the open/closed state determination may rely on the folding angle cross-verification performed by the second MCU 955 using the first folding angle sensor 920 and the second folding angle sensor 930 via the data line 970.

In case of measuring a magnetic force value equal to or greater than the operating point magnetic flux density (BOP), the magnetic force sensor 910 illustrated in FIG. 9 may confirm a closed state and output a low interrupt signal to the first MCU 950 and the second MCU 955. In case of measuring a magnetic force value less than the returning (or release) point magnetic flux density (BRP), the magnetic force sensor 910 may confirm an open state and output a high interrupt signal to the first MCU 950 and the second MCU 955. In case of measuring a magnetic force value equal to or greater than the operating point magnetic flux density (BOP), the magnetic force sensor 910 illustrated in FIG. 9 may confirm a closed state and output a low interrupt signal to the first MCU 950 and the second MCU 955. In case of measuring a magnetic force value less than the returning (or release) point magnetic flux density (BRP), the magnetic force sensor 910 may confirm an open state and output a high interrupt signal to the first MCU 950 and the second MCU 955. In an embodiment, the magnetic force sensor 910 may include a buck-boost converter 911, a Hall material 912, a comparator 913, and a push-pull block 915. The buck-boost converter 911 may supply a regulated voltage to the Hall material 912. The Hall material 912 may generate an analog signal corresponding to an intensity of an external magnetic force. The comparator 913 may compare the analog signal from the Hall material 912 with a reference voltage and may output a digital signal indicating whether the detected magnetic force corresponds to the open state or the closed state. A hysteresis between the BOP and the BRP of the comparator 913 may prevent oscillation of the output signal near a threshold. The push-pull block 915 may receive the digital signal from the comparator 913 and actively drive the interrupt line 980 to a high level or a low level, thereby providing a low-impedance output capable of simultaneously driving the interrupt inputs of both the first MCU 950 and the second MCU 955 connected in parallel to the interrupt line 980. In this regard, the comparator 913 of FIG. 9 may functionally correspond to the CPU 612 and the ADC 614 of FIG. 6 in that the comparator 913 converts the analog magnetic force signal into a digital determination, and the push-pull block 915 of FIG. 9 may functionally correspond to the interface 615 of FIG. 6 in that the push-pull block 915 drives the interrupt line 980.

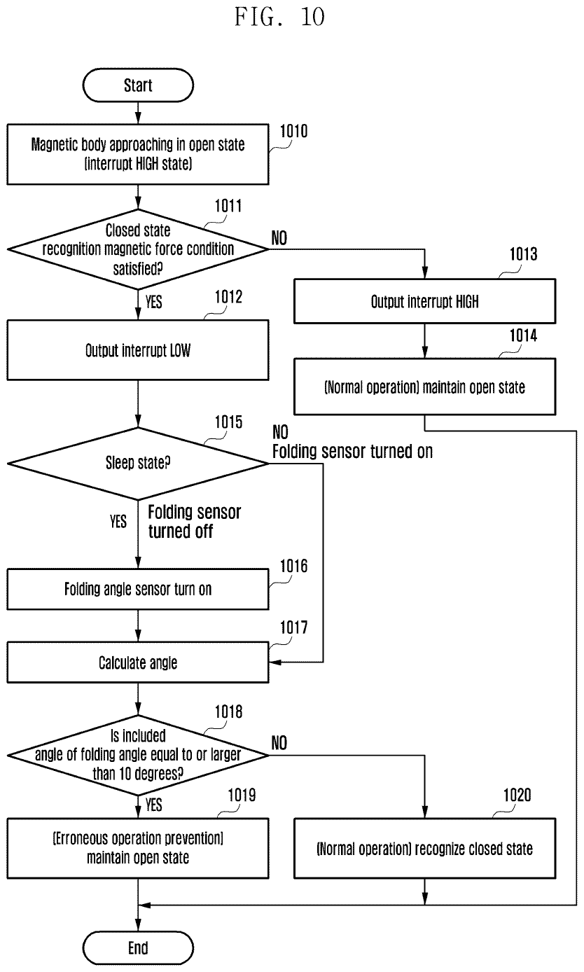

FIG. 10 is a flowchart of a method for preventing open/closed state recognition erroneous operations of an electronic device including a magnetic force sensor according to an embodiment of the disclosure.

In the following embodiments, respective operations may be sequentially performed, but are not necessarily performed in a sequential manner. For example, the order respective operations may be changed, and at least two operations may be performed in parallel.

Referring to FIG. 10, an electronic device 101 according to an embodiment includes the components in FIG. 9, and in operation 1010, may detect the approach of a magnetic body in the electronic device's open state (or in the unfolded state of the first housing 210 and the second housing 220). For example, the magnetic force sensor (e.g., the magnetic force sensor 520 in FIG. 5 or the magnetic force sensor 910 in FIG. 9) may detect a change in the magnetic force value caused by the approaching magnetic body.

In the open state of the electronic device, the magnetic force sensor 910 may output an interrupt high signal indicating a first state to the first MCU 950 and the second MCU 955 through the interrupt line.

In operation 1011, the magnetic force sensor 910 of the electronic device 101 may determine whether the measured change in magnetic force satisfies a first-axis magnetic force condition (e.g., a first recognition condition/a first reference value) configured to identify the closed state.

In operation 1012, in case that the magnetic force condition (e.g., first recognition condition) configured for closed state recognition is satisfied (yes in operation 1011), the magnetic force sensor 910 of the electronic device 101 may output a low signal as an interrupt signal indicating the closed state.

In operation 1013, in case that the magnetic force condition (e.g., first recognition condition) configured for closed state recognition is not satisfied (no in operation 1011), the magnetic force sensor 910 of the electronic device 101 may output a high signal as an interrupt signal indicating the open state.

In operation 1014, the processor 940 or the first MCU 950 of the electronic device 101 may maintain the opening/closing state of the electronic device 101 recognized as the open state by means of the high signal.

In operation 1015, the processor 940 or the first MCU 950 of the electronic device 101 may determine whether the electronic device 101 is in a sleep state.

In operation 1016, in case that the electronic device 101 is a in sleep state (yes in operation 1015), the processor 940 or the first MCU 950 of the electronic device 101 may turn on (or activate) the folding angle sensor (and the angle calculation processing unit) and, in case that the electronic device 101 is not in a sleep state (no in operation 1015), may skip operation 1016 and proceed to operation 1017.

In operation 1017, the processor 940 or the second MCU 655 of the electronic device 101 may calculate the folding angle, based on data transferred from the folding angle sensor through the data line 970.

In operation 1018, the processor 940 or the second MCU 955 of the electronic device 101 may determine whether the included angle of the folding is about 10 degrees or more.

In operation 1019, in case that the included angle of folding is about 10 degrees or more (yes in operation 1018), the processor 940 or the second MCU 955 of the electronic device 101 may maintain the opening/closing state of the electronic device 101 recognized as the open state.

In operation 1020, the processor 640 or the second MCU 655 of the electronic device 101 may recognize the opening/closing state of the electronic device 101 as a closed state in case that the included angle of folding is less than about 10 degrees (no in operation 1018).

Although not illustrated in the drawings, the electronic device 101 in FIG. 9 may perform the opening/closing recognition operation in the closed state after omitting operations 835 and 836 among the operations in FIG. 8B.

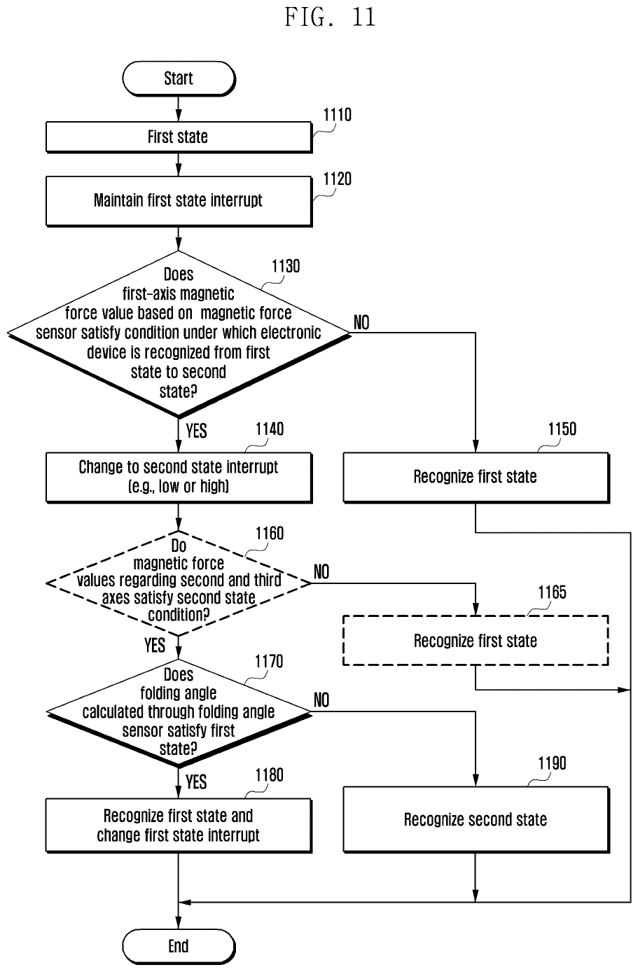

FIG. 11 is a flowchart of a method for preventing open/closed state recognition erroneous operations of an electronic device including a magnetic force sensor according to an embodiment of the disclosure.

In the following embodiments, respective operations may be sequentially performed, but are not necessarily performed in a sequential manner. For example, the order respective operations may be changed, and at least two operations may be performed in parallel.

Referring to FIG. 11, in operation 1110, an electronic device 101 according to an embodiment may recognize that the opening/closing state of the electronic device 101 is a first state (e.g., an open state or a closed state).

In operation 1120, in case that the opening/closing state of the electronic device 101 is the first state, the magnetic force sensor (e.g., the magnetic force sensor 520 in FIG. 5, the magnetic force sensor 610 in FIG. 6, or the magnetic force sensor 910 in FIG. 9) of the electronic device 101 may output a first state interrupt (or a first interrupt signal) to the first MCU (e.g., the first MCU 650 in FIG. 6 or the first MCU 950 in FIG. 9) and the second MCU (e.g., the second MCU 655 in FIG. 6 or the second MCU 955 in FIG. 9).

In operation 1130, the electronic device 101 may determine whether the first-axis magnetic force value measured by the magnetic force sensor satisfies the recognition condition under which the electronic device is recognized from the first state to the second state.

In operation 1140, in case that the first-axis magnetic force value measured by the magnetic force sensor satisfies the recognition condition under which the electronic device is recognized from the first state to the second state (yes in operation 1130), the electronic device 101 may change to a second state interrupt (or a second interrupt signal) and output the same to the first MCU and the second MCU.

In operation 1150, in case that that the first-axis magnetic force value measured by the magnetic force sensor does not satisfy the recognition condition under which the electronic device is recognized from the first state to the second state (no in operation 1130), the electronic device 101 may maintain the first state recognition.

In operation 1160, the electronic device 101 may determine whether the magnetic force value regarding the second axis and the third axis measured by the magnetic force sensor after outputting the second state interrupt satisfies the second state condition.

In operation 1165, in case that the magnetic force value regarding the second and third axes measured by the magnetic force sensor does not satisfy the second state condition (no in operation 1160), the electronic device 101 may maintain the first state recognition even if a second state interrupt is output.

In case that the magnetic force sensor is an analog Hall sensor, operations 1160 and 1165 may be omitted.

In operation 1170, in case that the magnetic force value regarding the second and third axes measured by the magnetic force sensor satisfies the second state condition (yes in operation 1160), the electronic device 101 may calculate the folding angle through the folding angle sensor and determine whether the folding angle satisfies the first state condition, under the control of the second MCU.

In operation 1180, in case that the folding angle satisfies the first state condition (yes in operation 1170), the electronic device 101 may, under the control of the second MCU, maintain the first state recognition and may change the output to a second state interrupt.

In this case, although the second state interrupt is output, the folding angle indicates the first state (not the second state), and the electronic device may accordingly ignore the second state interrupt output and maintain the first state recognition, thereby preventing opening/closing recognition errors caused by unintended magnetic force changes.

In operation 1190, in case that the folding angle does not satisfy the first state condition but satisfies the second state condition (no in operation 1170), the electronic device 101 may recognize that the opening/closing state of the electronic device is a second state under the control of the second MCU. In this case, the electronic device may finally recognize that second state recognition is a normal operation, based on the second state interrupt, because not only the result of measurement by the magnetic force sensor, but that by the folding angle sensor indicate the second state.

An electronic device 101 according to an embodiment may include a first housing 210, a second housing 210 foldably coupled to the first housing, a first magnetic body disposed in the first housing, a second magnetic body disposed in the second housing, a magnetic force sensor 610, 910 configured to detect a change in magnetic force according to the distance between the first magnetic body and the second magnetic body, at least one folding angle sensor 620,630, 920,630 configured to detect the folding angle between the first housing and the second housing, a first processor 650, 950 connected to the magnetic force sensor through a first data line configured to transfer data from the magnetic force sensor and an interrupt line configured to transfer an interrupt signal in case that a magnetic force condition is satisfied based on a change in magnetic force, a second processor 655, 955 connected to the at least one folding angle sensor through a second data line which branches off from a node of the interrupt line so as to be connected to the magnetic force sensor and transfers data from the at least one folding angle sensor, and memory 130. The memory 130 may include instructions which, when executed, cause the magnetic force sensor to output a first interrupt signal indicating a second state to the first processor and the second processor through the interrupt line in case that, while the electronic device is recognized as being in a first state, a first recognition condition which causes a change from the first state to the second state is satisfied by a change in magnetic field measured by the magnetic force sensor, cause the second processor to activate the at least one second folding angle sensor and an angle calculation processing unit in response to receiving the first interrupt signal, thereby calculating the folding angle between the first housing and the second housing, and cause the first processor or the second processor to maintain recognition of the first state in case that the folding angle is included in a first state condition, and recognize that the electronic device has changed to the second state in case that the folding angle is outside the first state condition.

According to an embodiment, the first processor may include a first microcontroller unit (MCU) configured to operate in a state in which the electronic device is powered on and the display is turned on, or in an operating state after booting is completed, and the second processor may include a second MCU configured to operate in a state in which the electronic device is powered off, and an external power supply is connected thereto, in a sleep state of the electronic device, or in a low-power state before booting.

According to an embodiment, the memory may further include instructions which cause the magnetic force sensor to output a second interrupt signal indicating the first state through the interrupt line in case that a change in magnetic force measured by the magnetic force sensor satisfies a second recognition condition which causes a change from the second state to the first state.

According to an embodiment, the magnetic force sensor may be implemented as one of a digital Hall sensor configure to measure magnetic force values along a first axis, a second axis, and a third axis according to the distance between the first magnetic body and the second magnetic body, or as an analog Hall sensor configured to measure one magnetic force value.

According to an embodiment, in case that the magnetic force sensor is implemented as the digital Hall sensor, the magnetic force sensor may have the first recognition condition and the second recognition condition configure based on the magnetic force value along the first axis, which has the largest difference in magnetic force according to a change in state of the electronic device, among magnetic force values along the first axis, the second axis, and the third axis.

According to an embodiment, the memory may further include instructions which cause the first sensor to determine, based on receiving the first interrupt signal, whether magnetic force values regarding the second axis and the third axis, among data transferred from the magnetic force sensor, satisfy a second state recognition condition and, in case that magnetic force values regarding the second axis and the third axis do not satisfy the second state recognition condition, request the second processor to calculate the folding angle.

According to an embodiment, the memory may further include instructions which cause the first processor to determine whether the electronic device is in a sleep mode in case that magnetic force values regarding the second axis and the third axis do not satisfy the second state recognition condition, and request the second processor to activate the at least one second sensor in case that the electronic device is in a sleep mode.

According to an embodiment, the memory may further include instructions which cause first processor to determine whether the electronic device is in a sleep state after the magnetic force sensor outputs a first interrupt signal in case that the magnetic force value regarding the first axis or the one magnetic force value satisfies the first recognition condition which causes a change from the first state to the second state, and cause the second processor to activate the at least one second sensor in case that the electronic device is in a sleep mode.

According to an embodiment, the at least one folding angle sensor may include a first folding angle sensor configured to measure changes in angular velocity and acceleration related to movements of the first housing, and a second folding angle sensor configured to measure changes in angular velocity and acceleration related to movements of the second housing.

According to an embodiment, the second processor may be implemented inside a main processor (e.g., the main processor 121 in FIG. 1) or an application processor, or may be disposed outside the main processor or the application processor.

According to an embodiment, the memory may further include instructions which cause the second processor to deactivate the at least one folding angle sensor and the angle calculation processing unit after completing the electronic device state recognition.

A method for preventing opening/closing recognition erroneous operations of an electronic device according to an embodiment may include: an operation in which the magnetic force sensor outputs a first interrupt signal indicating a second state to the first processor and the second processor through the interrupt line in case that, while the electronic device is recognized as being in a first state, a first recognition condition which causes a change from the first state to the second state is satisfied by a change in magnetic field measured by the magnetic force sensor; an operation in which the second processor activates the at least one folding angle sensor and an angle calculation processing unit in response to receiving the first interrupt signal, thereby calculating the folding angle between the first housing and the second housing; an operation in which the first processor or the second processor maintains recognition of the first state in case that the folding angle is included in a first state condition; and an operation of recognizing that the electronic device has changed from the first state to the second state in case that the folding angle is outside the first state condition.

According to an embodiment, the operation of outputting the first interrupt signal to the first processor and the second processor may further include an operation in which the first processor determines, based on receiving the first interrupt signal, whether magnetic force values regarding the second axis and the third axis, among data transferred from the magnetic force sensor, satisfy a second state recognition condition, and an operation in which, in case that magnetic force values regarding the second axis and the third axis do not satisfy the second state recognition condition, the second processor is requested to calculate the folding angle.

According to an embodiment, the operation of determining whether magnetic force values regarding the second axis and the third axis satisfy a second state recognition condition may further include an operation in which the first processor determines whether the electronic device is in a sleep mode in case that magnetic force values regarding the second axis and the third axis do not satisfy the second state recognition condition, and an operation in which the second processor activates the at least one folding angle sensor in case that the electronic device is in a sleep mode.

According to an embodiment, the operation of outputting the first interrupt signal to the first processor and the second processor may further include an operation in which the first processor determines whether the electronic device is in a sleep state after the magnetic force sensor outputs a first interrupt signal in case that the magnetic force value regarding the first axis or the one magnetic force value satisfies the first recognition condition which causes a change from the first state to the second state, and an operation in which the second processor activates the at least one folding angle sensor in case that the electronic device is in a sleep mode.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a first housing;
a second housing foldably coupled to the first housing;
a first magnetic body disposed in the first housing;
a second magnetic body disposed in the second housing;
a first sensor configured to detect a change in magnetic force based on a distance between the first magnetic body and the second magnetic body;
at least one second sensor configured to detect a folding angle between the first housing and the second housing;
a first processor connected to the first sensor through a first data line and an interrupt line, the first data line being configured to transfer first sensor data and the interrupt line being configured to transfer an interrupt signal in response to a magnetic force condition being satisfied based on a change in magnetic force;
a second processor connected to the at least one second sensor through a second data line configured to transfer second sensor data, the second data line branching off from a node of the interrupt line so as to be connected to the first sensor; and
memory, comprising one or more storage media, storing executable instructions,
wherein the instructions, when executed by at least one of the first processor or the second processor, cause:
the first sensor to output a first interrupt signal indicating a second state to the first processor and the second processor through the interrupt line in case that, while the electronic device is recognized as being in a first state, a first recognition condition which causes a change from the first state to the second state is satisfied by a change in magnetic field measured by the first sensor,
the second processor to activate the at least one second sensor and angle calculation processing circuitry in response to receiving the first interrupt signal, thereby calculating the folding angle between the first housing and the second housing, and
the first processor or the second processor to maintain recognition of the first state in case that the folding angle is included in a first state condition, and recognize that the electronic device has changed to the second state in case that the folding angle is outside the first state condition.

2. The electronic device of claim 1,
wherein the first processor comprises a first microcontroller unit (MCU) configured to operate in a state in which the electronic device is powered on and a display of the electronic device is turned on, or in an operating state after booting is completed, and
wherein the second processor comprises a second MCU configured to operate in a state in which the electronic device is powered off, and an external power supply is connected thereto, in a sleep state of the electronic device, or in a low-power state before booting.

3. The electronic device of claim 1, wherein the instructions, when executed by at least one of the first processor or the second processor, further cause:
the first sensor to output a second interrupt signal indicating the first state through the interrupt line in case that the change in magnetic force measured by the first sensor satisfies a second recognition condition which causes a change from the second state to the first state.

4. The electronic device of claim 3, wherein the first sensor is implemented as one of a digital Hall sensor configure to measure magnetic force values along a first axis, a second axis, and a third axis according to the distance between the first magnetic body and the second magnetic body, or as an analog Hall sensor configured to measure one magnetic force value.

5. The electronic device of claim 4, wherein, in case that the first sensor is implemented as the digital Hall sensor, the first sensor has the first recognition condition and the second recognition condition configured based on a magnetic force value along the first axis, which has a largest difference in magnetic force according to a change in state of the electronic device, among magnetic force values along the first axis, the second axis, and the third axis.

6. The electronic device of claim 5, wherein the instructions, when executed by at least one of the first processor or the second processor, further cause:
the first processor to determine, based on receiving the first interrupt signal, whether magnetic force values regarding the second axis and the third axis, among data transferred from the first sensor, satisfy a second state recognition condition, and
in case that the magnetic force values regarding the second axis and the third axis do not satisfy the second state recognition condition, the first processor to request the second processor to calculate the folding angle.

7. The electronic device of claim 6, wherein the instructions, when executed by at least one of the first processor or the second processor, further cause:
the first processor to determine whether the electronic device is in a sleep mode in case that the magnetic force values regarding the second axis and the third axis do not satisfy the second state recognition condition, and
the first processor to request the second processor to activate the at least one second sensor in case that the electronic device is in a sleep mode.

8. The electronic device of claim 4, wherein the instructions, when executed by at least one of the first processor or the second processor, further cause:
the first processor to determine whether the electronic device is in a sleep state after the first sensor outputs the first interrupt signal in case that a magnetic force value regarding the first axis or the one magnetic force value satisfies the first recognition condition which causes the change from the first state to the second state, and
the second processor to activate the at least one second sensor in case that the electronic device is in a sleep mode.

9. The electronic device of claim 1, wherein the at least one second sensor includes a first folding angle sensor configured to measure changes in angular velocity and acceleration related to movements of the first housing, and a second folding angle sensor configured to measure changes in angular velocity and acceleration related to movements of the second housing.

10. The electronic device of claim 1, wherein the second processor is implemented inside a main processor or an application processor.

11. The electronic device of claim 1, wherein the second processor is disposed outside a main processor or outside an application processor.

12. The electronic device of claim 1, wherein the instructions, when executed by at least one of the first processor or the second processor, further cause:
the second processor to deactivate the at least one second sensor and the angle calculation processing circuitry after completing recognition of which state the electronic device is in.

13. A method performed by an electronic device for preventing opening/closing recognition erroneous operations of the electronic device, the electronic device including a first housing, a second housing foldably coupled to the first housing, a first magnetic body disposed in the first housing, a second magnetic body disposed in the second housing, a first sensor configured to detect a change in magnetic force according to a distance between the first magnetic body and the second magnetic body, at least one second sensor configured to detect a folding angle between the first housing and the second housing, a first processor connected to the first sensor through a first data line and an interrupt line, the first data line being configured to transfer first sensor data and the interrupt line being configured to transfer an interrupt signal in case that a magnetic force condition is satisfied based on the change in magnetic force, a second processor connected to the at least one second sensor through a second data line configured to transfer data from the at least one second sensor, the second data line branching off from a node of the interrupt line so as to be connected to the first sensor, and memory, comprising one or more storage media, storing instructions, the method comprising:
outputting, by the first sensor, a first interrupt signal indicating a second state to the first processor and the second processor through the interrupt line in case that, while the electronic device is recognized as being in a first state, a first recognition condition which causes a change from the first state to the second state is satisfied by a change in magnetic field measured by the first sensor;
activating, by the second processor, the at least one second sensor and angle calculation processing circuitry in response to receiving the first interrupt signal, thereby calculating the folding angle between the first housing and the second housing;
maintaining, by the first processor or the second processor, recognition of the first state in case that the folding angle is included in a first state condition; and
recognizing that the electronic device has changed from the first state to the second state in case that the folding angle is outside the first state condition.

14. The method of claim 13,
wherein the first processor includes a first microcontroller unit (MCU) configured to operate in a state in which the electronic device is powered on and a display of the electronic device is turned on, or in an operating state after booting is completed, and
wherein the second processor includes a second MCU configured to operate in a state in which the electronic device is powered off, and an external power supply is connected thereto, in a sleep state of the electronic device, or in a low-power state before booting.

15. The method of claim 13, wherein the first sensor is implemented as one of a digital Hall sensor configured to measure magnetic force values along a first axis, a second axis, and a third axis according to the distance between the first magnetic body and the second magnetic body, or as an analog Hall sensor configured to measure one magnetic force value.

16. The method of claim 15, wherein the outputting of the first interrupt signal to the first processor and the second processor comprises:
determining, by the first processor, whether the electronic device is in a sleep state after the first sensor outputs a first interrupt signal in case that a magnetic force value regarding the first axis or the one magnetic force value satisfies the first recognition condition which causes the change from the first state to the second state; and
activating, by the second processor, the at least one second sensor in case that the electronic device is in a sleep mode.

17. The method of claim 16, further comprising:
outputting, by the first sensor, a second interrupt signal indicating the first state through the interrupt line in case that the change in magnetic force measured by the first sensor satisfies a second recognition condition which causes a change from the second state to the first state.

18. The method of claim 17, wherein, in case that the first sensor is implemented as the digital Hall sensor, the first sensor has the first recognition condition and the second recognition condition configured based on a magnetic force value along the first axis, which has a largest difference in magnetic force according to a change in state of the electronic device, among magnetic force values along the first axis, the second axis, and the third axis.

19. The method of claim 18, further comprising:
based on receiving the first interrupt signal, determining, by the first processor, whether magnetic force values regarding the second axis and the third axis, among data transferred from the first sensor, satisfy a second state recognition condition; and
in case that the magnetic force values regarding the second axis and the third axis do not satisfy the second state recognition condition, requesting, by the first processor, the second processor to calculate the folding angle.

20. One or more non-transitory computer-readable storage media storing one or more computer programs including computer-executable instructions that, when executed by one or more processors of an electronic device individually or collectively, in which the electronic device includes a first housing, a second housing foldably coupled to the first housing, a first magnetic body disposed in the first housing, a second magnetic body disposed in the second housing, a first sensor configured to detect a change in magnetic force according to a distance between the first magnetic body and the second magnetic body, at least one second sensor configured to detect a folding angle between the first housing and the second housing, a first processor connected to the first sensor through a first data line and an interrupt line, the first data line being configured to transfer first sensor data and the interrupt line being configured to transfer an interrupt signal in case that a magnetic force condition is satisfied based on the change in magnetic force, a second processor connected to the at least one second sensor through a second data line configured to transfer data from the at least one second sensor, the second data line branching off from a node of the interrupt line so as to be connected to the first sensor, and memory, comprising one or more storage media, storing instructions, cause the electronic device to perform operations, the operations comprising:
outputting, by the first sensor, a first interrupt signal indicating a second state to the first processor and the second processor through the interrupt line in case that, while the electronic device is recognized as being in a first state, a first recognition condition which causes a change from the first state to the second state is satisfied by a change in magnetic field measured by the first sensor;
activating, by the second processor, the at least one second sensor and angle calculation processing circuitry in response to receiving the first interrupt signal, thereby calculating the folding angle between the first housing and the second housing;
maintaining, by the first processor or the second processor, recognition of the first state in case that the folding angle is included in a first state condition; and
recognizing that the electronic device has changed from the first state to the second state in case that the folding angle is outside the first state condition.
